(19) United States
(12) Patent Application Publication
(10) Pub. No.: US 2017/0349057 A1
(43) Pub. Date: Dec. 7, 2017

(54) COMMUNICATION TERMINAL, COMMUNICATION TERMINAL WITH ELECTRODE, COMMUNICATION SYSTEM, ELECTRICALLY DRIVEN VEHICLE, AND CHARGING APPARATUS

(71) Applicant: Panasonic Intellectual Property Management Co., Ltd., Osaka (JP)

(72) Inventors: AKIHIKO NAMBA, Osaka (JP); HIROKAZU KITAMURA, Osaka (JP)

(73) Assignee: Panasonic Intellectual Property Management Co., Ltd., Osaka (JP)

(21) Appl. No.: 15/540,102

(22) PCT Filed: Dec. 18, 2015
(86) PCT No.: PCT/JP2015/006314

§ 371 Date: Jun. 27, 2017

(30) Foreign Application Priority Data
Jan. 15, 2015 (JP) 2015-006099
Jan. 19, 2015 (JP) 2015-008006

(51) Int. Cl. B60L 11/18; B60R 16/03; H02J 7/00

(52) U.S. Cl. CPC B60L 11/1846; H02J 7/0027; B60R 16/03; B60L 11/1816; B60L 11/1838; B60L 11/1861

(57) ABSTRACT

A communication terminal includes a communication unit and a controller. The communication unit is provided in a supply apparatus that supplies electric power from a power source to an electric device through a feeding line, and is configured to communicate with a destination terminal provided in the electric device. The controller is configured to control a switch to switch turning on and off of the switch electrically connected to the feeding line. The feeding line includes a first line that electrically connects between the power source and the switch, and a second line that electrically connects between the switch and the electric device. At least one of the communication unit and the destination terminal is located away via a space from a conductive member included in the feeding line as to be electrically connected to an electrode coupled via electric field to the conductive member. The communication unit is configured to communicate with the destination terminal by using a signal transmitted via a conductive member included in the second line of the conductive member as a medium. The controller is configured to turn off the switch for a communication period for which the communication unit communicates with the destination terminal.

### TECHNICAL FIELD

The present invention generally relates to a communication terminal, an electrode-attached communication terminal, a communication system, an electric vehicle, and a charging apparatus, and more particularly to a communication terminal, an electrode-attached communication terminal, a communication system, an electric vehicle, and a charging apparatus used for communication between an electric device and a supply apparatus.

### BACKGROUND ART

PTL 1 discloses a conventional power line connection device control system that allows automatic recognition of a type of electric device connected to each connection port (outlet) of a connection device. A power line carrier signal transmit-receive system is applied to the system described in PTL 1. A home server (control apparatus) is connected to a power line via a power line communication (PLC) modem. In this system, when an electric device that complies with the standard for power line carrier signal transmit-receive system is connected to the plug socket, the electric device exchanges signals with the home server via the power line and the PLC modem, and then a recognition process is performed.

However, since this system requires wiring work to connect the PLC modem directly to the power line, it is difficult to provide a communication function to an existing device later. When a power line to which relatively high voltage (for example, AC 200 V) is applied is used, the PLC modem may require relatively high-withstand-voltage components.

Meanwhile, PTL 2 discloses, for example, application of short-range wireless that uses an electromagnetic wave for communication between an electric device, such as an electric-powered vehicle and a supply apparatus (a charging stand) that supplies electric power to the electric device. In the supply apparatus described in PTL 2, the communication with the electric device (e.g., electric vehicle) is used, for example, for a billing process according to an amount of charging or the like.

### CITATION LIST

### Patent Literature

PTL 1: Japanese Patent Laid-Open Publication No. 2003-110471

PTL 2: Japanese Utility Model No. 3148265

### SUMMARY

A communication terminal includes a communication unit and a controller. The communication unit is provided in a supply apparatus that supplies electric power from a power source to an electric device through a feeding line, and is configured to communicate with a destination terminal provided in the electric device. The controller is configured to control a switch to switch turning on and off of the switch electrically connected to the feeding line. The feeding line includes a first line that electrically connects between the power source and the switch, and a second line that electrically connects between the switch and the electric device. At least one of the communication unit and the destination terminal is located away via a space from a conductive member included in the feeding line as to be electrically connected to an electrode coupled via electric field to the conductive member. The communication unit is configured to communicate with the destination terminal by using a signal transmitted via a conductive member included in the second line of the conductive member as a medium. The controller is configured to turn off the switch for a communication period for which the communication unit communicates with the destination terminal.

The communication terminal can perform one-to-one communication even when the supply apparatus and the electric device exist within a short distance under a one-to-plural or plural-to-one relationship.

### BRIEF DESCRIPTION OF DRAWINGS

FIG. 1 is a schematic block diagram of a communication system according to Exemplary Embodiment 1.

FIG. 2 is a configuration diagram of a charging system that uses the communication system according to Embodiment 1.

FIG. 3 is a perspective view of a main part of an example of an installed first communication terminal according to Embodiment 1.

FIG. 4A is a perspective view of a main part of an electrode according to Embodiment 1for illustrating an installing process thereof.

FIG. 4B is a perspective view of the main part an installed electrode according to Embodiment 1.

FIG. 4C is a perspective view of a charging cable which is a supply line according to Embodiment 1.

FIG. 4D is a perspective view of a main part of another example of the installed first communication terminal according to Embodiment 1.

FIG. 5A is a perspective view of a main part of the electrode according to Embodiment 1for illustrating an installation process thereof.

FIG. 5B is a perspective view of the main part the installed electrode according to Embodiment 1.

FIG. 6A is a cross-sectional view of a main part of an example of the electrode according to Embodiment 1.

FIG. 6B is an enlarged sectional view of a main part of the electrode illustrated in FIG. 6A.

FIG. 7A is a perspective view of a main part of a ground terminal according to Embodiment 1 for illustrating a process for connecting the ground terminal.

FIG. 7B is a perspective view of the main part of the ground terminal according to Embodiment 1 for illustrating a connection of the ground terminal.

FIG. 8A is a perspective view of a main part of an example of an installed second communication terminal according to Exemplary Embodiment 1.

FIG. 8B is a perspective view of a main part of an example of an installed second communication terminal according to Exemplary Embodiment 1.

FIG. 9 is a schematic block diagram of a supply apparatus according to Embodiment 1.

FIG. 10 is a schematic block diagram of the communication system according to Embodiment 1 for illustrating an operation of the communication system.

FIG. 11 is a perspective view of a main part of an installed first communication terminal according to Exemplary Embodiment 2.

FIG. 12 is a perspective view of a main part of an example of an installed first communication terminal according to Exemplary Embodiment 3.

FIG. 13 is a plan view of an electric vehicle and a charging apparatus that use a communication system according to a fifth exemplary embodiment.

FIG. 14 is a schematic block diagram of a communication system according to a sixth exemplary embodiment.

### DETAIL DESCRIPTION OF PREFERRED EMBODIMENTS

### Exemplary Embodiment 1

In the following exemplary embodiments, a communication terminal, electrode-attached communication terminal, communication system, electric vehicle, and charging apparatus which are used for a charging system of an electric vehicle equipped with a secondary battery as one example will be described. An outline of the charging system will be described below.

### <Outline of Charging System>

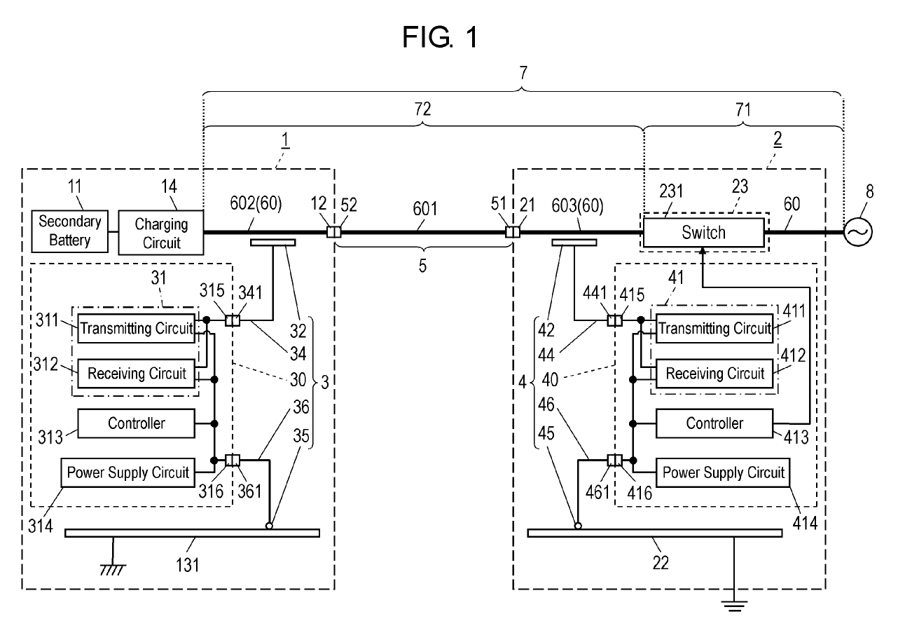

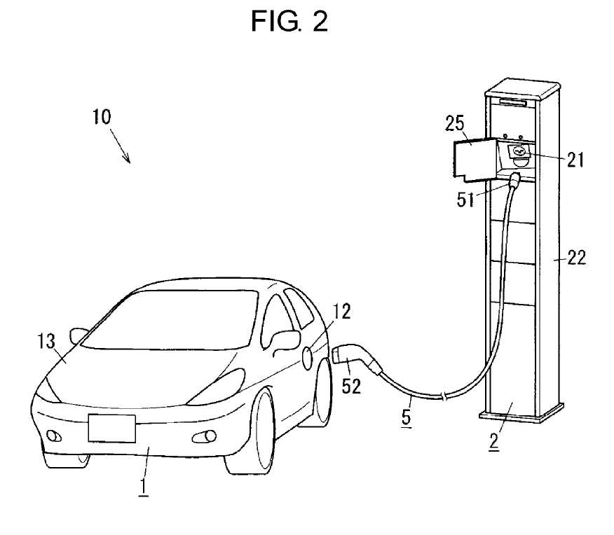

FIG. 1 is a schematic block diagram of a communication system according to Exemplary Embodiment 1. FIG. 2 is a schematic diagram of charging system 10 that uses the communication system according to

Embodiment 1. Charging system 10 includes electric vehicle 1 and charging apparatus 2, as illustrated in FIG. 2.

In accordance with the present embodiment, charging apparatus 2 charges secondary battery 11 installed to electric vehicle 1 (shown in FIG. 1) by supplying, to electric vehicle 1, electric power supplied from commercial power source (system power source) or a power generating facility, such as a photovoltaic power generating facility. That is, charging apparatus 2 supplies, to electric vehicle 1, electric power supplied from power supply 8 (commercial power source or a power generating facility) via feeding line 7. While the electric power to be supplied to charging apparatus 2 from the commercial power source or power generating facility may be either one of alternating current power and direct current power, the following describes a case of alternating current power as an example. The electric power to be supplied from charging apparatus 2 to electric vehicle 1 may also be either one of alternating current power and direct current power. The following describes a case of alternating current power as an example.

According to the embodiment, charging apparatus 2 is, for example, a charging stand installed on a ground in a parking lot of a commercial establishment, a public facility, or a collective housing. Charging apparatus 2 includes charging plug socket 21 (outlet) to which charging cable 5 is to be electrically connected. Charging plug socket 21 is configured to allow plug 51 of charging cable 5 to be detachably connected thereto. Charging plug socket 21 is electrically connected to feeding circuit 23 accommodated in housing 22 of charging apparatus 2 (shown in FIG. 1). Accordingly, while charging cable 5 is connected to charging plug socket 21, charging apparatus 2 supplies electric power from feeding circuit 23 via charging cable 5 to electric vehicle 1.

Charging apparatus 2 includes lid 25 provided in front of charging plug socket 21 in housing 22. Lid 25 is configured to be opened and closed. While lid 25 is opened, charging plug socket 21 is exposed. While lid 25 is closed, charging plug socket 21 is covered with lid 25. Lid 25 is normally closed. When charging apparatus 2 is used, lid 25 is opened and plug 51 of charging cable 5 is plugged into and unplugged from charging plug socket 21. That is, in order to connect charging cable 5 to charging plug socket 21, a user opens lid 25 and plugs plug 51 into charging plug socket 21, and then closes lid 25. In order to disconnect charging cable 5 from charging plug socket 21, the user opens lid 25 and unplugs plug 51 from charging plug socket 21, and then closes lid 25. A space large enough to accommodate plug 51 is provided between lid 25 and charging plug socket 21 so that lid 25 is closed while charging cable 5 is connected to charging plug socket 21.

Charging apparatus 2 includes switch 231 (see FIG. 1) electrically connected to feeding line 7. Switch 231 is provided in feeding circuit 23. Switch 231 is inserted into feeding line 7 that connects power source 8 to electric vehicle 1. Conduction and non-conduction between power source 8 and electric vehicle 1 are switched along with switching of turning on and off of switch 231. That is, while charging apparatus 2 is connected to electric vehicle 1 via charging cable 5, when switch 231 is turned on (closed), power source 8 is electrically connected to electric vehicle 1 via feeding line 7, and electric power is supplied from power source 8 to electric vehicle 1. While charging apparatus 2 is connected to electric vehicle 1 via charging cable 5, when switch 231 is turned off (opened), power source 8 is electrically disconnected from electric vehicle 1, and electric power supply from power source 8 to electric vehicle 1 is stopped. Switch 231 is, for example, an electromagnetic relay, and is configured to be turned on and off in accordance with a control signal input from a controller of a communication terminal to be detailed later.

Feeding line 7 includes first line 71 (see FIG. 1) that electrically connects power source 8 to switch 231, and second line 72 (see FIG. 1) that electrically connects switch 231 to electric vehicle 1. That is, feeding line 7 is divided into first line 71 and second line 72 with switch 231 as a boundary between lines 71 and 72. A portion of the feeding line 7 on the side of power source 8 from switch 231 is first line 71 while a portion of the feeding line 7 on the side of electric vehicle 1 from switch 231 is second line 72. First line 71 is electrically connected to second line 72 when switch 231 is turned on. First line 71 is electrically disconnected from second line 72 when switch 231 is turned off. Charging cable 5 that connects charging apparatus 2 to electric vehicle 1 is included in second line 72 of feeding line 7. Feeding circuit 23 may include, for example, a measurement circuit for measuring an amount of electric power supplied to electric vehicle 1, and a voltage conversion circuit for performing voltage conversion, in addition to switch 231.

Electric vehicle 1 has secondary battery 11 installed thereto. Battery 11 is charged with charging apparatus 2. Electric vehicle 1 runs using electric energy stored in secondary battery 11. While the following describes an electric-powered vehicle (EV) that runs using output of a motor as an example of electric vehicle 1, electric vehicle 1 is not limited to the electric-powered vehicle. Electric vehicle 1 may be, for example, a plug-in hybrid vehicle (PHEV) that runs by combining engine output and motor output, a two-wheel vehicle (an electric motorcycle), a tricycle, or a power-assisted bicycle.

Electric vehicle 1 includes charging inlet 12 to which connector 52 of charging cable 5 is to be electrically connected. Charging inlet 12 is configured to allow connector 52 of charging cable 5 to be detachably connected thereto. Charging inlet 12 is electrically connected to charging circuit 14 (refer to FIG. 1) accommodated in car body 13 of electric vehicle 1. Accordingly, while charging cable 5 is connected to charging inlet 12, electric vehicle 1 receives electric power from charging apparatus 2 via charging cable 5, and charges secondary battery 11 by charging circuit 14.

Charging system 10 may have any configuration to exchange electric power (electric energy) between charging apparatus 2 and electric vehicle 1, and charging system 10 is not limited to the configuration to perform only charging of secondary battery 11. That is, charging system 10 may be configured to discharge secondary battery 11. In this case, charging system 10 can perform V2G (Vehicle to Grid), for example, by supplying electric power of secondary battery 11 from charging apparatus 2 to a distribution network.

In charging system 10 described above, an authentication process of electric vehicle 1 may be performed, for example, in order to perform billing according to an amount of charging, or in order to determine whether electric vehicle 1 is a vehicle to which charging is permitted or not. These applications require a communication between electric vehicle 1 and charging apparatus 2. Therefore, in accordance with the following embodiments, the communication terminal, electrode-attached communication terminal, and communication system which are used for the communication between electric vehicle 1, which is an electronic device, and charging apparatus 2, which is a supplying apparatus, in charging system 10 will be described.

Although the configuration of the electrode-attached communication terminal as first communication terminal 3 as an example in accordance with the present embodiment will be described, an electrode-attached communication terminal with a configuration common to the configuration of first communication terminal 3 is also used as second communication terminal 4. Therefore, unless otherwise specified, the following describes the electrode-attached communication terminal as first communication terminal 3 (also referred to as “electrode-attached communication terminal 3”), and the description of the electrode-attached communication terminal as second communication terminal 4 (also referred to as “electrode-attached communication terminal 4”) is omitted.

As illustrated in FIG. 1, electrode-attached communication terminal 3 according to the present embodiment includes communication unit 31, electrode 32, and ground terminal 35.

Communication unit 31 is provided in the electric device (electric vehicle 1), and is configured to communicate with a destination terminal (second communication terminal 4). The destination terminal is provided in the supply apparatus that supplies electric power from power source 8 to electric device through feeding line 7. Electrode 32 is configured to be located away via a space from conductive member 60 included in feeding line 7, so as to be coupled via electric field to conductive member 60. Here, conductive member 60 coupled via electric field to electrode 32 includes at least one of first conductor 601 included in charging cable 5, and second conductor 602 electrically connected to first conductor 601. Ground terminal 35 functions as a reference potential point of communication unit 31.

Communication unit 31 is electrically connected to electrode 32 and ground terminal 35, and is configured to communicate with the destination terminal by using a signal transmitted via conductive member 60 included in second line 72 of conductive member 60 as a medium. Ground terminal 35 is electrically connected to conductive part 131 of the electric device (electric vehicle 1). Conductive part 131 is made of conductive material.

In electrode-attached communication terminal 3, electrode 32 is electrically coupled to conductive member 60 while not contacting conductive member 60 by being coupled via electric field to conductive member 60. A signal is exchanged with the destination terminal via by using conductive member 60 as a medium to allow electrode-attached communication terminal 3 to perform electric field communication with the destination terminal. The electric field communication is a communication in which a predetermined signal propagates through a particular communication path (conductive member 60) mainly by using a static electrostatic field or a quasi-electrostatic field. For example, the electric field communication is communication that transmits a predetermined signal by using an electric field that occurs between conductive member 60 and the ground. Components of an electric field (static electrostatic field or quasi-electrostatic field) at a position attenuate in proportion to the third power of the distance from the position to electrode 32 when propagating through space. That is, the electric field used by the electric field communication mentioned here rapidly attenuates depends on the distance from electrode 32. Unlike radiated waves of wireless communication, the signal transmitted by this electric field communication does not propagate through a space with little attenuation. This electric field communication establishes communication between terminals connected through a particular communication path instead of an unspecified path in space. Also, in the electric field communication mentioned here, since attenuation of the electric field while propagating through conductive member 60 is smaller than a case of propagating through space, communication can be established with very small energy although non-contact, compared with wireless communication using radiated waves.

In the above configuration, in electrode-attached communication terminal 3, ground terminal 35 constituting the reference potential point of communication unit 31 is electrically connected to conductive part 131. Conductive part 131 mentioned here is a portion with conductivity, and may be a metal portion that is substantially equipotential in car body 13 (see FIG. 2) including a frame and body. In general, conductive part 131 is electrically connected to a negative terminal of a battery for electric parts (different from secondary battery 11 for driving). In other words, ground terminal 35 connected to conductive part 131 grounds communication unit 31 to the body. This configuration reduces impedance of the reference potential point of communication unit 31 more than a case where ground terminal 35 is not electrically connected to conductive part 131 (electrically isolated), thus stabilizing a potential of the reference potential point.

In more detail, in a case where electrode-attached communication terminal 3 communicates with the destination terminal, when communication unit 31 applies a signal to electrode 32, an electric field occurs between conductive member 60 and the ground, for example, as described above. At this moment, if ground terminal 35 is not connected to conductive part 131, both conductive part 131 that exists near electrode 32 and the ground can be end points of electric force lines that start from electrode 32, hence preventing the electric field from being unstable. For example, one electric force line flows along a path extends from electrode 32 as a starting point to conductive part 131 as an end point and further extends from conductive part 131 as a starting point to the ground as an end point. Another electric force line flows along a path that extends from electrode 32 directly to the ground. Thus, various electric fields (paths of electric force line) exist, and the signal used in the above-described electric field communication is likely to be affected by an installation position of electrode-attached communication terminal 3 and conductive part 131 around electrode-attached communication terminal 3. Such unstable electric field may cause variations in a signal transmission efficiency and reduction in the signal. Meanwhile, when ground terminal 35, which is the reference potential point of communication unit 31, is connected to conductive part 131, the end points of the electric force lines that start from electrode 32 is converged on conductive part 131. This provides stable electric field used for the electric field communication and improves the signal transmission efficiency.

Conductive member 60 is preferably made of metal. Although communication can be established even if conductive member 60 is made of conductive resin, such as, conductive polymer since metal generally has higher conductivity than conductive resin, conductive member 60 made of metal can reduce a loss in the communication path. Also, for example, although communication can be established even if a medium that is mainly made of water is used as conductive member 60, such as a human body, water hose, and piping for water, this medium can lead to large loss in the communication path in a similar manner to the conductive resin. Furthermore, such a medium mainly made of water does not have a stable shape, and for example, substantial electrical conductivity of a human body will change depending on posture thereof or the like. Therefore, conductive member 60 made of metal is more preferable to communication stability.

In the present exemplary embodiment, as an example, the electric device is electric vehicle 1. The supply apparatus is charging apparatus 2. Feeding line 7 includes charging cable 5 that connects electric vehicle 1 to charging apparatus 2. In the present exemplary embodiment, for first communication terminal 3 provided in electric vehicle 1, second communication terminal 4 is the destination terminal, and first communication terminal 3 communicates with second communication terminal 4. In contrast, for second communication terminal 4 provided in charging apparatus 2, first communication terminal 3 is the destination terminal, and second communication terminal 4 communicates with first communication terminal 3.

The electrode-attached communication terminal according to the present exemplary embodiment will be detailed below. However, the configuration to be described below is only one example of the present invention, the present invention is not limited to the following exemplary embodiment, and various changes according to design or the like can be made, even other than this exemplary embodiment, without departing from technical ideas according to the present invention.

### <Configuration of Electrode-Attached Communication Terminal>

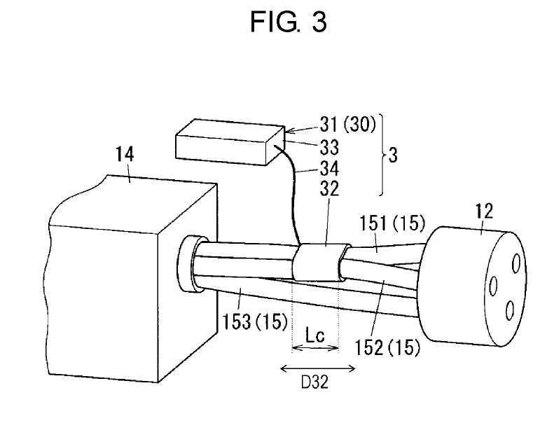

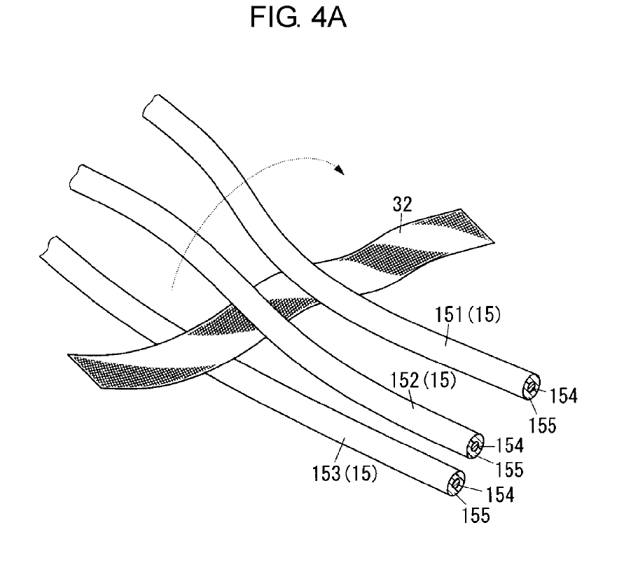

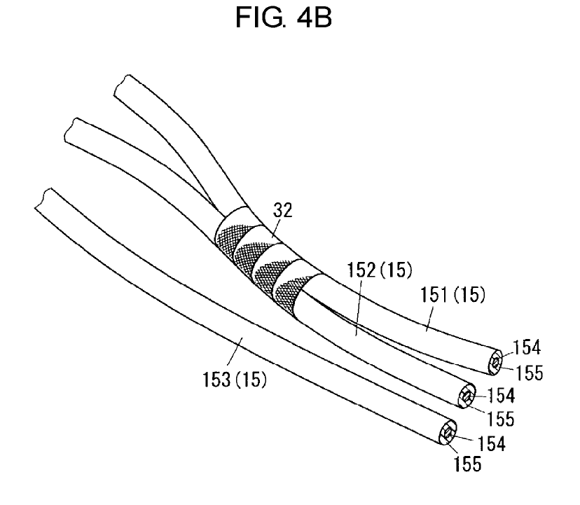

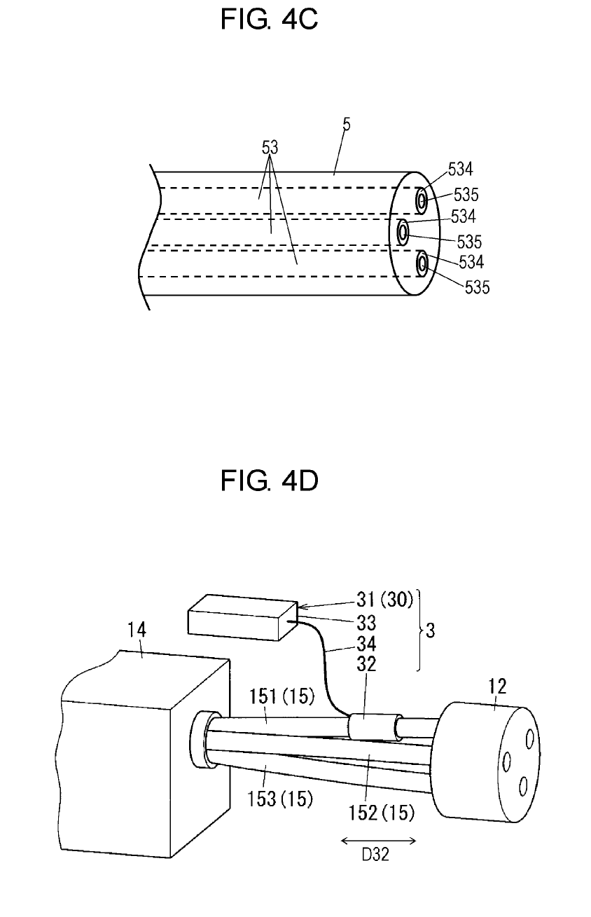

FIG. 3 is a perspective view of a, main part of installed first communication terminal 3 according to Embodiment 1. FIG. 4A and FIG. 4B are perspective views of main parts of electrode 32 for illustrating an installation process thereof. In addition to communication unit 31, electrode 32, and ground terminal 35 described above, electrode-attached communication terminal 3 according to the present embodiment further includes controller 313, power supply circuit 314, case 33 (refer to FIG. 3), cable 34 that connects communication unit 31 to electrode 32, and cable 36. Case 33 accommodates therein communication unit 31, controller 313, and power supply circuit 314. Cable 36 connects communication unit 31 to ground terminal 35.

Electrode 32 is electrically connected to communication unit 31 via cable 34. Since electrode-attached communication terminal 3 according to the present exemplary embodiment performs electric field communication while electrode 32 is electrically coupled to conductive member 60 while not contacting conductive member 60, electrode 32 is used while not directly contacting conductive member 60.

FIG. 4C is a perspective view of charging cable 5 which is the supply line in accordance with Embodiment 1. First conductor 601 included in the supply line includes core wire 534 (see FIG. 4) of electric wire 53 (see FIG. 4) included in charging cable 5. Second conductor 602 electrically connected to first conductor 601 includes core wire 154 (refer to FIG. 4A) of internal wire 15 (refer to FIG. 3) that electrically connect charging inlet 12 and charging circuit 14 in the electronic device (electric vehicle 1). Each of these electric wires (electric wire 53 and internal wire 15) is, for example, a vinyl insulated wire in which a copper core wire is covered with a sheath made of, e.g. vinyl. Electrode 32 is located away via a space from conductive member 60 including at least one of first conductor 601 and second conductor 602 as described above, thereby being coupled via electric field to conductive member 60. In accordance with the present embodiment, conductive member 60 includes second conductor 602 while electrode 32 is coupled via electric field to second conductor 602.

Here, in accordance with the present embodiment, electrode 32 is configured to be coupled via electric field to conductive member 60 by being capacitively coupled to conductive member 60. Here, a capacitance component formed between electrode 32 and conductive member 60 (hereinafter referred to as “coupling capacitance”) is determined by a distance from electrode 32 to conductive member 60 and a dielectric constant of a substance that lies between electrode 32 and conductive member 60. A space large enough to form a coupling capacitance may be provided between electrode 32 and conductive member 60. It is not essential that sheath 155 lies between electrode 32 and conductive member 60, and that, for example, a gap (space) may exist between electrode 32 and conductive member 60.

Electrode 32 coupled via electric field to conductive member 60 by capacitive coupling can reduce a coupling loss between electrode 32 and conductive member 60. Although electric field coupling between electrode 32 and conductive member 60 can also be performed, for example, by disposing electrode 32 including a wire to be entwined conductive member 60, such electric field coupling causes a larger coupling loss than capacitive coupling. In capacitive coupling, since electrode 32 faces a surface of conductive member 60 in parallel, the coupling loss between electrode 32 and conductive member 60 can be reduced.

As detailed later, electrode 32 is preferably made of a conductive sheet. For example, electrode 32 is more preferably made of, e.g. a mesh metal sheet, a metal foil, or a metal tape.

Communication unit 31 includes transmitting circuit 311 and receiving circuit 312, as illustrated in FIG. 1.

Transmitting circuit 311 is electrically connected to electrode 32, and is configured to generate a transmission signal that contains information by modulating a carrier wave (carrier) and to apply the transmission signal to electrode 32. Transmitting circuit 311 uses, for example, a rectangular wave having a frequency of about 10 [MHz] as the carrier wave, and employs On Off Keying (OOK) as a modulation method. When transmitting circuit 311 applies the transmission signal to electrode 32, an electric field (quasi-electrostatic field) is induced in conductive member 60 coupled via electric field to electrode 32. The electric field induced in conductive member 60 propagates through conductive member 60 with a little attenuation, and then, reaches the supply device (charging apparatus 2). Receiving circuit 412 of the destination terminal (second communication terminal 4) provided in the supply device thus receives the transmission signal.

Receiving circuit 312 is electrically connected to electrode 32, and is configured to receive the transmission signal from the destination terminal.

Receiving circuit 312 receives the transmission signal induced in electrode 32 by the electric field generated in conductive member 60 coupled via electric field to electrode 32. Then, receiving circuit 312 demodulates the transmission signal to extract information contained in the transmission signal.

Controller 313 mainly includes a micro processing unit (MPU) configured to control transmitting circuit 311 and receiving circuit 312. This configuration enables communication unit 31 to communicate with the destination terminal (second communication terminal 4) by using the signal transmitted via conductive member 60 as a medium. Communication unit 31 including both transmitting circuit 311 and receiving circuit 312 can exchange the transmission signal, and can perform bidirectional communication with the destination terminal.

Power supply circuit 314 is configured to supply electric power for operations to transmitting circuit 311, receiving circuit 312, and controller 313. Power supply circuit 314 includes, for example, a primary battery as a power supply, and supplies electric power of the primary battery to the circuits.

Ground terminal 35 is electrically connected to communication unit 31 via cable 36. Ground terminal 35 is electrically connected to each of transmitting circuit 311, receiving circuit 312, controller 313, and power supply circuit 314, and functions as a reference potential point of each circuit. That is, for power supply circuit 314, for example, since ground terminal 35 is electrically connected to an output terminal on a lower (negative) potential side, power supply circuit 314 outputs a voltage corresponding to a potential difference between an output terminal on a higher (positive) potential side and ground terminal 35 as a power source voltage.

As detailed later, ground terminal 35 preferably has a structure, such as a spade terminal, suitable for being grounded to the body. That is, ground terminal 35 is electrically connected to conductive part 131 made of a conductive material out of car body 13 of electric vehicle 1, and thus ground terminal 35 preferably has a structure suitable to be electrically connected to conductive part 131.

Communication unit 31 is configured to communicate with the destination terminal while the electronic device is connected to the supply apparatus via feeding line 7. Communication unit 31 is configured not to communicate with the destination terminal while the electronic device is connected to the supply apparatus via the feeding line. In accordance with the embodiment, as described above, the electronic device is electric vehicle 1, the supply apparatus is charging apparatus 2, and feeding line 7 includes charging cable 5. Second communication terminal 4 is the destination terminal for first communication terminal 3 provided in electric vehicle 1.

Therefore, communication unit 31 of first communication terminal 3 communicates with second communication terminal 4 while electric vehicle 1 is connected to charging apparatus 2 via charging cable 5. Communication unit 31 does not communicate with second communication terminal 4 while electric vehicle 1 is not connected to charging apparatus 2 via charging cable 5. It is determined whether or not electric vehicle 1 is connected to charging apparatus 2 via charging cable 5, based on a detection result of a connection detector that detects a connection status of plug 51 of charging cable 5 to charging plug socket 21.

When the connection detector detects that plug 51 is connected to charging plug socket 21, communication unit 31 determines that the electronic device is connected to the supply apparatus via feeding line 7, and then, communication unit 31 communicates with second communication terminal 4 which is the destination terminal. On the other hand, when the connection detector detects that the connection between plug 51 and charging plug socket 21 is canceled, communication unit 31 determines that the electronic device is not connected to the supply apparatus via feeding line 7, and then, does not communicate with second communication terminal 4 which is the destination terminal. The connection detector may be included in communication unit 31, but may be provided separately from communication unit 31. The connection detector is configured to detect the connection status of plug 51 of charging cable 5 to charging plug socket 21 optically, for example, by using reflection of infrared light or the like, or to detect the connection status electrically based on an electric power application state. Instead of the connection status of plug 51 to charging plug socket 21, the connection detector may detect the connection status of connector 52 of charging cable 5 to charging inlet 12.

That is, first communication terminal 3 and second communication terminal 4 mainly use an electric field component that attenuates in proportion to the third power of a distance from electrode 32 when propagating through space, and performs communication by electric field communication by which a predetermined signal propagates through a particular communication path (conductive member 60). Accordingly, even when electric vehicle 1 is not connected to charging apparatus 2 via charging cable 5, first communication terminal 3 and second communication terminal 4 can be in a communicative status, e.g. when plug 51 of charging cable 5 exists near charging plug socket 21. By communicating with the destination terminal only when the electronic device is connected to the supply apparatus via feeding line 7 as described above, communication unit 31 can communicate only when being connected via a wire similarly to a wired communication although non-contact.

The connection detector that determines whether or not electric vehicle 1 is connected to charging apparatus 2 via charging cable 5 is not essential. The communication system according to the present embodiment functions when the electric device is connected to the supply apparatus via feeding line 7 and first communication terminal 3 and second communication terminal 4 can communicate with each other. For example, when second communication terminal 4 receives a signal transmitted from first communication terminal 3, the communication path for electric field communication is not established before electric vehicle 1 is connected to charging apparatus 2 (via charging cable 5). Accordingly, the signal from first communication terminal 3 propagates through space before reaching second communication terminal 4, and a signal strength received at second communication terminal 4 is very small. When electric vehicle 1 is connected to charging apparatus 2 (via charging cable 5) in this state, the communication path for electric field communication is established, and the signal strength received at second communication terminal 4 increases rapidly. A receiving strength difference is, for example, ranges from 40 [dB] to 70 [dB] between before and after electric vehicle 1 is connected to charging apparatus 2 via charging cable 5 although it depends on the distance between electric vehicle 1 and charging apparatus 2, the size of electric vehicle 1, and the length of charging cable 5. This value of the reception strength difference is one example when the distance between electric vehicle 1 and charging apparatus 2 is about 1 [m] and overall length of electric vehicle 1 is about 2 [m] to 5 [m]. That is, by setting receiving sensitivity of the communication terminal on a signal receiving side in accordance with this value of the signal reception strength difference, first communication terminal 3 and second communication terminal 4 can communicate with each other only when electric vehicle 1 is connected to charging apparatus 2 via charging cable 5. In other words, through setting of the receiving sensitivity, communication unit 31 is configured to communicate with the destination terminal while the electric device is connected to the supply apparatus via feeding line 7, and not to communicate with the destination terminal while the electric device is not connected to the supply apparatus via feeding line 7.

Even while plug 51 of charging cable 5 is located immediately close to charging plug socket 21, the receiving strength difference is equal to or greater than 20 [dB] when compared with a case where electric vehicle 1 is connected to charging apparatus 2 via charging cable 5. The receiving sensitivity is set in accordance with the difference, and thereby, first communication terminal 3 and second communication terminal 4 can determine whether or not electric vehicle 1 is connected to charging apparatus 2 via charging cable 5 with establishment of communication. Therefore, the connection detector for determining whether or not electric vehicle 1 is connected to charging apparatus 2 via charging cable 5 is not essential.

### <Configuration of Communication Terminal>

Communication unit 31 of electrode-attached communication terminal 3 with the above described configuration, together with controller 313 and power supply circuit 314, constitutes communication terminal 30 including neither electrode 32 nor ground terminal 35. That is, communication terminal 30 according to the present embodiment includes communication unit 31 and controller 313. Communication terminal 30 includes feeding connection terminal 315 electrically connected to electrode 32. Communication terminal 30 further includes ground connection terminal 316 electrically connected to ground terminal 35.

Connector 341 provided at an end of cable 34 opposite to electrode 32 is detachably connected to feeding connection terminal 315. That is, while connector 341 is connected to feeding connection terminal 315, feeding connection terminal 315 is electrically connected to electrode 32 via cable 34. Feeding connection terminal 315 is disposed to be exposed from a part of case 33.

Connector 361 provided at an end of cable 36 opposite to ground terminal 35 is detachably connected to ground connection terminal 316. That is, while connector 361 is connected to ground connection terminal 316, ground connection terminal 316 is electrically connected to ground terminal 35 via cable 36. Ground terminal 35 is disposed to be exposed from a part of case 33.

Communication terminal 30 thus configured, together with electrode 32 and ground terminal 35, constitutes electrode-attached communication terminal 3 described above by connecting electrode 32 to feeding connection terminal 315 and connecting ground terminal 35 to ground connection terminal 316. Therefore, when plural types of electrodes 32 exist, communication terminal 30 can connect and use arbitrary electrode 32 out of plural types of electrodes 32. When plural types of ground terminals 35 exist, communication terminal 30 can connect and use arbitrary ground terminal 35 out of plural types of ground terminals 35.

### <Configuration of Electrode>

A configuration of electrode 32 will be described below.

In accordance with the embodiment, electrode 32 is a conductive sheet. Since electrode 32 is made of conductive material, electrode 32 can, for example, efficiently convert the transmission signal (electric power) output from transmitting circuit 311 into an electric field, and superimpose the converted transmission signal on first conductor 601 or second conductor 602 as the electric field. This is because the entire of electrode 32 made of conductive material is generally equipotential to generate almost no electric loss, allowing the transmission signal to be applied onto the entire of electrode 32 substantially uniformly without a loss. This configuration reduces a loss of the transmission signal in a communication path, such as a path from transmitting circuit 311 to receiving circuit 412 of the destination terminal (second communication terminal 4). Communication unit 31 can thus reduce electric power necessary for communication. In particular, when communication unit 31 is power by a battery, this configuration prolongs the battery life and the battery replacement cycle.

Electrode 32 may be made of non-conductive material (electrically insulating material), such as synthetic resin. Even in this case, electrode 32 can be coupled via electric field to conductive member 60. However, in electrode 32 made of electrically insulating material, a potential on a surface of electrode 32 becomes non-uniform, and the electric loss on the surface of electrode 32 is larger than electrode 32 made of conductive material, which may cause a larger transmission loss.

Electrode 32 is coupled via electric field to second conductor 602 by being wound around internal wire 15, as illustrated in FIG. 3. Electrode 32 is wound around internal wire 15 on sheath 155 (refer to FIG. 4A).

In other words, with respect to internal wire 15 having the structure in which second conductor 602 composed of core wire 154 is covered with sheath 155, electrode 32 is disposed as to face second conductor 602 across sheath 155 without breaking sheath 155. Therefore, a distance from electrode 32 to second conductor 602 is generally identical to the thickness of sheath 155. Thus, electrode 32 which is located away via a space of the thickness of sheath 155 from conductive member 60 (second conductor 602), is capacitively coupled (electric field coupling) to conductive member 60.

In accordance with the embodiment, electrode 32 surrounds conductive member 60 in an entire circumference of a circumferential direction of conductive member 60. That is, in the case that conductive member 60 (second conductor 602) is composed of core wire 154 of internal wire 15, electrode 32 surrounds conductive member 60 in the entire circumference of the circumferential direction in a cross-section perpendicular to an extending direction (lengthwise direction) of internal wire 15. This configuration ensures the facing area of electrode 32 facing conductive member 60 as large as possible, and reduces the transmission loss. That is, when the facing area of electrode 32 facing conductive member 60 increases, a coupling capacitance between electrode 32 and conductive member 60 increases, accordingly decreasing the transmission loss. Note that methods for reducing the transmission loss (coupling loss) in a coupling section between electrode 32 and conductive member 60 include a method for matching impedance in addition to the above-described method. For example, impedance of communication terminal 30 (communication unit 31) from electrode 32 is determined to be matched with impedance of electrode 32 from communication terminal 30 at a frequency of the carrier wave of the transmission signal, thereby decreasing the coupling loss. As in the present exemplary embodiment, in the case where the frequency of the carrier wave is about 10 [MHz], when the impedance of communication terminal 30 from electrode 32 is similar to the impedance of electrode 32 from communication terminal 30 at about 10 [MHz], which is the frequency of the carrier wave, the coupling loss can be reduced.

Electrode 32 may not necessarily surround conductive member 60 in the entire circumference of the circumferential direction of conductive member 60. Electrode 32 may surround conductive member 60 except for a part of conductive member 60 in the circumferential direction of conductive member 60. Even in the case where there is no space around internal wire 15 to wind electrode 32 in the entire circumference of the circumferential direction of internal wire 15, electrode 32 can be coupled via electric field to conductive member 60.

In accordance with the embodiment, it is assumed that a wiring between charging apparatus 2 and electric vehicle 1 is single-phase three-wire system 100V wiring. That is, as illustrated in FIG. 3 and FIG. 4D, internal wire 15 as conductive member 60 includes neutral line 153 of N phase and a pair of voltage lines 151 and 152 of L1 phase and L2 phase. Neutral line 153 is electrically connected, for example, to a stable potential point, such as the ground, via charging cable 5 of charging apparatus 2.

That is, neutral line 153 is grounded. This configuration causes a voltage of neutral line 153 with respect to the ground to become 0 [V], and causes a voltage of each of the pair of voltage lines 151 and 152 with respect to the ground to become 100 [V]. The voltage between one voltage line 151 (L1 phase) and neutral line 153 (N phase) becomes 100 [V], the voltage between another voltage line 152 (L2 phase) and neutral line 153 (N phase) becomes 100 [V]. The voltage between the pair of voltage lines 151, 152 becomes 200 [V].

That is, conductive member 60 includes neutral line 153 and voltage lines 151 and 152. Electrode 32 is configured to be coupled via electric field only to voltage lines 151 and 152 out of neutral line 153 and voltage lines 151 and 152. In the configuration shown in FIG. 3, as the pair of voltage lines 151 and 152 is bundled with electrode 32, electrode 32 is wound around two of three internal wires 15 (both voltage lines 151 and 152). On the other hand, in the example shown in FIG. 4D, electrode 32 is wound only around one voltage line 151 out of the pair of voltage lines 151 and 152. In the example shown in FIG. 4D, electrode 32 is wound so as to closely adhere to sheath 155 with almost no gap.

Thus, electrode 32 is preferably coupled via electric field only to voltage lines 151 and 152 excluding neutral line 153 of conductive member 60. That is, in the electric field communication, since signals are transmitted using an electric field generated between conductive member 60 and a reference potential point, neutral line 153 which can be the reference potential point is preferably not included in conductive member 60. Electrode 32 is coupled via electric field to both of the pair of voltage lines 151 and 152, as illustrated in FIG. 3.

FIG. 4D is a perspective view of a main part of another example of installed first communication terminal according to Embodiment 1. In FIG. 4D, components identical to those of the first communication terminal illustrated in FIG. 3 are denoted by the same reference numerals. Electrode 32 illustrated in FIG. 4D is coupled via electric field only to one of the pair of voltage lines 151 and 152, and is not coupled via electric field to the other of the pair of voltage lines 151 and 152. Comparing these configurations, the signal receiving strength is higher in the configuration shown in FIG. 3 (electrode 32 is coupled via electric field to both of the pair of voltage lines 151 and 152) than in the configuration shown FIG. 4D (electrode 32 is coupled via electric field only to one of the pair of voltage lines 151 and 152).

In the examples shown in FIG. 4A and FIG. 4B, electrode 32 is a mesh sheet having a strip shape, and is wound around internal wire 15 plural turns around internal wire 15. In this configuration, electrode 32 preferably has a configuration in which an adhesive is coated on one surface in terms of workability. In this configuration, electrode 32 is relatively thin and easy to wind, and thus it is easy to wind electrode 32 around relatively thin (with a small diameter) internal wire 15 so as to cause electrode 32 to adhere securely thereto.

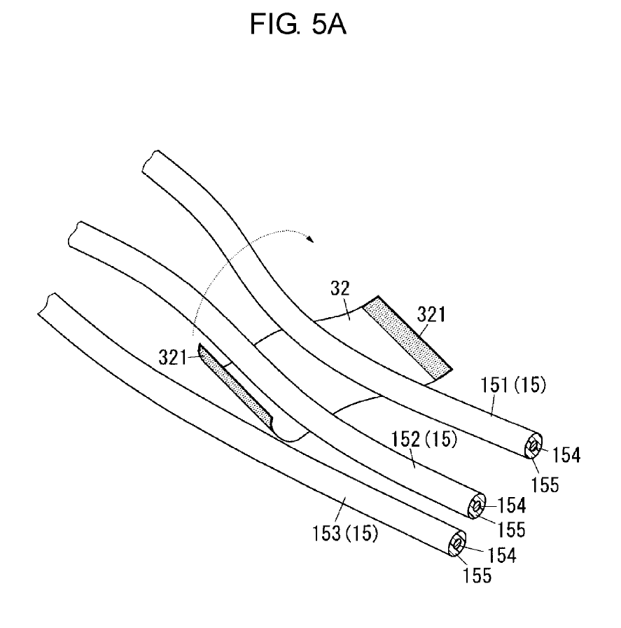

FIG. 5A and FIG. 5B are perspective views of a main part of still another installment process of electrode 32 according to Embodiment 1. In the examples shown in FIG. 5A and FIG. 5B, hook-and-loop fastener 321 is provided on both sides of electrode 32. In this configuration, electrode 32 is wound around internal wire 15 and fixed with hook-and-loop fastener 321 on both sides of electrode 32 while being rolled around internal wire 15. Since electrode 32 is detachable in this configuration, electrode-attached communication terminal 3 including electrode 32 can be easily removed from internal wire 15 at a time of, e.g. maintenance of electrode-attached communication terminal 3.

Electrode 32 is preferably made of a mesh metal sheet, a metal foil, a metal tape, or the like as described above. This configuration allows electrode 32 to closely adhere to the surface of internal wire 15 easily, and reduces the transmission loss. In particular, the mesh metal sheet more preferably adheres to the surface of internal wire 15 than the metal foil or the metal tape. The mesh metal sheet can be wound around internal wire 15 with almost no air layer that lies between internal wire 15 and the metal sheet. In short, magnitude of a coupling capacitance between electrode 32 and conductive member 60 is determined by a distance from electrode 32 to conductive member 60 and a dielectric constant of the substance that lies between electrode 32 and conductive member 60. The transmission loss decreases as the coupling capacitance increases. Therefore, electrode 32 securely adhering to internal wire 15 reduces the distance from electrode 32 to conductive member 60, and prevents an air layer from lying between electrode 32 and conductive member 60, thereby providing a large coupling capacitance and a small transmission loss.

In the case that electrode 32 has a mesh structure, internal wire 15 is exposed from meshes of electrode 32, hence not being covered with electrode 32 completely. However, when a high-frequency transmission signal with the carrier wave having a frequency equal to or higher than several megahertz is used for communication, electrode 32 failing to cover internal wire 15 completely does not much affect the transmission loss.

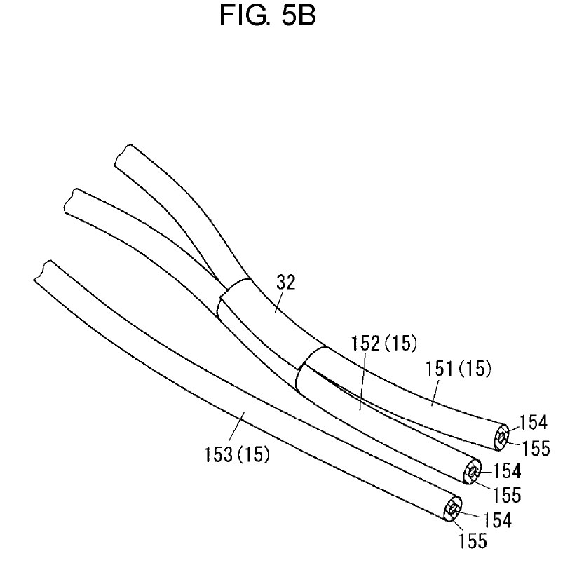

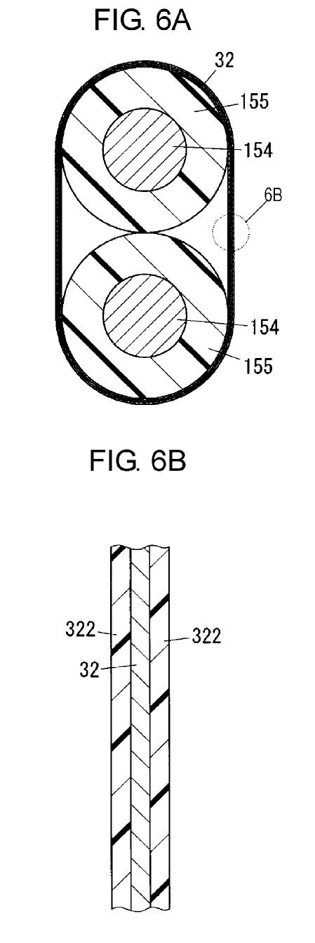

FIG. 6A is a cross-sectional view of a main part of another example of electrode 32 according to Embodiment 1. FIG. 6B is an enlarged sectional view of section 6B of electrode 32 illustrated in FIG. 6A. Electrode-attached communication terminal 3 may further include electrical insulator 322 that covers electrode 32 as illustrated in FIG. 6A and FIG. 6B. In the examples shown in FIG. 6A and FIG. 6B, electrical insulator 322 made of sheath material made of synthetic resin covers both sides of electrode 32. Electrical insulator 322 is formed, for example, by coating electrode 32 with the resin or winding a tape with electrical insulation properties around electrode 32. This structure prevents electrode 32 from directly contacting a metal conductor around internal wire 15. Since electrode 32 is protected by electrical insulator 322, even when electrode 32 is made of copper or other materials, aged deterioration of electrode 32 caused by rust or the like is inhibited, resulting in that low transmission loss can be maintained over long periods. For purposes of rust prevention of electrode 32, electrical insulator 322 preferably has a water shielding property so as to prevent water from attaching to electrode 32. Electrical insulator 322 may be provided only on one side of electrode 32. In this case, electrode 32 is wound around internal wire 15 with a surface of electrode 32 facing electrical insulator 322 being outside, and electrode 32 is not exposed from electrical insulator 322.

In the case that conductive member 60 has a linear shape or a tubular shape extending in extending direction D32, the length of electrode 32 in extending direction D32 of conductive member 60 is preferably smaller than ¼ of a wavelength of the above-described signal. In the following, the length of electrode 32 in extending direction D32 of conductive member 60 is referred to as coupling length Lc of electrode 32 (refer to FIG. 3). That is, when the signal used in electrode-attached communication terminal 3 for communication has a wavelength λ [ml], coupling length Lc of electrode 32 is preferably less than λ/4 [m]. The signal wavelength X mentioned here is a wavelength of the carrier wave (carrier) of the transmission signal. For example, when transmitting circuit 311 transmits the signal (transmission signal) by using the carrier wave of 10 [MHz] as described above, the signal wavelength λ is 30 [m]. In this case, coupling length Lc of electrode 32 is preferably less than 7.5 [m] (=30/4 [m]). In this structure, electrode 32 is unlikely to function as an antenna for an electromagnetic wave of wavelength λ identical to the wavelength of the transmission signal, and electrode 32 is less susceptible to electromagnetic waves.

### <Configuration of Ground Terminal>

A configuration of ground terminal 35 will be described below.

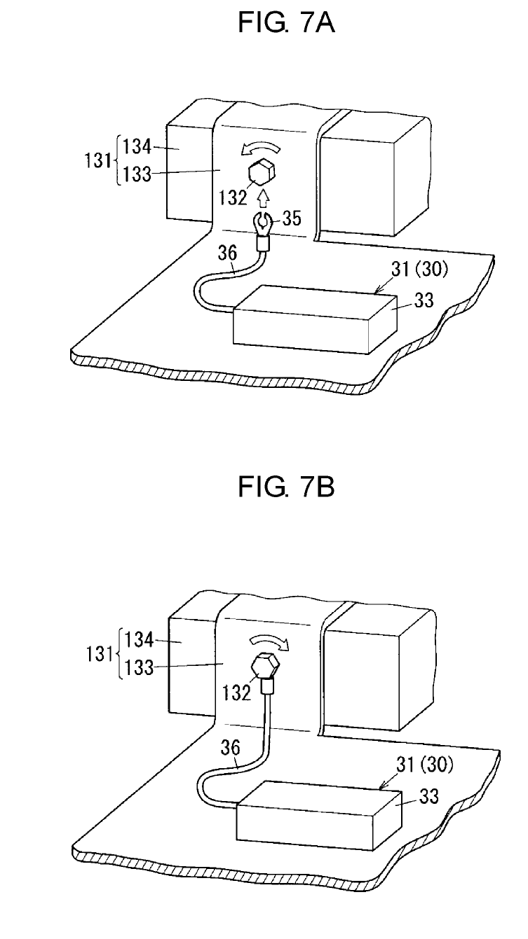

FIG. 7A and FIG. 7B are perspective views of a main part of a process of connecting ground terminal 35 according to Embodiment 1. In the present embodiment, ground terminal 35 includes a spade terminal that can be fastened together with conductive part 131 with screw 132 (a male screw, such as a hexagon head bolt or a truss screw, or a female screw, such as a nut), as illustrated in FIG. 7A. Ground terminal 35 is electrically connected to conductive part 131 with screw 132 tightly fastened originally to conductive part 131. That is, during installation of ground terminal 35, an operator first loosens appropriate screw 132 tightly fastened to conductive part 131, as illustrated in FIG. 7A, and then, inserts ground terminal 35 into a gap formed between screw 132 and conductive part 131. In the example shown in FIG. 7A, screw 132 (hexagon head bolt) that fixes metal plate 133 to frame 134 is used for installing ground terminal 35. While being fixed to frame 134 with screw 132, metal plate 133 is electrically connected to frame 134. Metal plate 133 and frame 134 are included in conductive part 131.

After inserting ground terminal 35 into the gap between screw 132 and conductive part 131, the operator tightens screw 132 to tightly fasten ground terminal 35 together with metal plate 133 with screw 132, as illustrated in FIG. 7B. At this moment, ground terminal 35 is electrically connected to metal plate 133 and frame 134 which constitute conductive part 131. Thus, ground terminal 35 is electrically connected to conductive part 131 and is grounded via a fastening portion of screw 132 in conductive part 131 as a grounding point.

Ground terminal 35 is connected to conductive part 131 without processing conductive part 131. Screw 132 tightly fastened maintains a small contact resistance between ground terminal 35 and conductive part 131. In particular, since ground terminal 35 is a spade terminal, ground terminal 35 can be connected only by loosening screw 132 without removing screw 132 completely, providing preferable workability. However, the spade terminal is just an example of ground terminal 35, and ground terminal 35 may be a round terminal or any other terminal

Conductive part 131 to which ground terminal 35 is connected is a portion with conductivity, such as a metal portion that is substantially equipotential in car body 13 of electric vehicle 1 as described above. The surface area of conductive part 131 is preferably larger than the surface area of ground terminal 35. Ground terminal 35 connected to conductive part 131 provides stable electric field used for electric field communication and further improvement in the signal transmission efficiency. That is, since the electric field does not occur within the conductor, ground terminal 35 as the reference potential point of communication unit 31 connected to conductive part 131 with a larger surface area stabilizes the electric field significantly. As a result, this configuration allows further improvement in the signal transmission efficiency.

The volume of conductive part 131 is preferably larger than the volume of ground terminal 35. Ground terminal 35 connected to conductive part 131 provides stable electric field used for electric field communication and further improvement in the signal transmission efficiency. That is, since impedance of a conductor decreases as the thickness of the conductor increases, ground terminal 35 as the reference potential point of communication unit 31 connected to conductive part 131 with a larger volume provides small impedance of the reference potential point significantly. As a result, this configuration provides stable potential of the reference potential point easily, and further improves the signal transmission efficiency.

In accordance with the present embodiment, both of the surface area and volume of conductive part 131 is larger than both of the surface area and volume of ground terminal 35, respectively. However, this configuration is not necessarily required, and one or both of the surface area and volume of conductive part 131 may be smaller than one or both of the surface area and volume of ground terminal 35, respectively.

As another configuration example, ground terminal 35 may be a terminal that is connected to an already-installed ground wiring electrically connected to conductive part 131. That is, when a ground wiring connected to conductive part 131 exists near a fixing position of communication unit 31 in car body 13, ground terminal 35 is connected to this ground wiring, and is electrically connected to conductive part 131. In this case, ground terminal 35 can be, for example, with a terminal such as a screw terminal connected to a distal end of the ground wiring, an electrotap that allows the ground wiring to branch through connection in an intermediate portion of the ground wiring.

As still another configuration example, ground terminal 35 may be electrically connected to case 33 of communication unit 31. That is, in the case that case 33 is made of a conductive metal, ground terminal 35 may be electrically connected to conductive part 131 with ground terminal 35 being electrically connected to case 33 and case 33 being connected to conductive part 131. In this case, case 33 or a metal stay for installing case 33 is fastened together to conductive part 131 with screw 132, and thus ground terminal 35 is electrically connected to conductive part 131 via case 33.

The resistance between an arbitrary portion in conductive part 131 and ground terminal 35 is preferably equal to or less than several hundred [ohms]. This configuration increases the above-described effect produced by electrical connection of ground terminal 35 to conductive part 131.

### <Method for Installing Electrode-Attached Communication Terminal>

When installing electrode-attached communication terminal 3, an operator fixes communication unit 31 of electrode-attached communication terminal 3 to a predetermined position of electric vehicle 1 (electronic device), and causes electrode 32 to be coupled via electric field to conductive member 60. At this moment, the operator can cause electrode 32 to be coupled via electric field to conductive member 60 by winding electrode 32 on sheath 155 around internal wire 15.

The operator fixes communication unit 31 by fixing case 33 together with a bolt near charging inlet 12 in the car body of electric vehicle 1. A fixing position where communication unit 31 is fixed to electric vehicle 1 is determined according to a length of cable 34 so as to allow cable 34 to connect communication unit 31 to electrode 32. In the case that communication unit 31 includes a primary battery as a power source in power supply circuit 314, the operator does not need to connect an external power source to communication unit 31 in order to secure electric power for operating communication unit 31.

The operator electrically connects ground terminal 35 to conductive part 131. At this moment, by fastening ground terminal 35 composed of a spade terminal with screw 132 together to conductive part 131 as described above, the operator can electrically connect ground terminal 35 to conductive part 131. In the case that screw 132 is tightly fastened to conductive part 131 near the fixing position of communication unit 31 around charging inlet 12, the operator preferably connects ground terminal 35 with screw 132.

Thus, during installation of electrode-attached communication terminal 3 according to the present embodiment in electric vehicle 1, the operator does not need to electrically connect electrode 32 of electrode-attached communication terminal 3 to an electric system of electric vehicle 1, and can perform installation with relatively simple work without processing the electric system of electric vehicle 1. Therefore, when electric vehicle 1 as the electric device has a space for installing electrode-attached communication terminal 3, electrode-attached communication terminal 3 can be easily installed to electric vehicle 1 as the electric device by post-installation. The operation for connecting ground terminal 35 to conductive part 131 does not involve processing of electric system of the electric vehicle 1, and thus, does not prevent post-installation of electrode-attached communication terminal 3.

### <Configuration of Second Communication Terminal>

In accordance with the embodiment, as described above, first communication terminal 3 provided in the electronic device has the same basic configuration as second communication terminal 4 provided in the supply apparatus. Therefore, the description of electrode-attached communication terminal 3 described above as first communication terminal 3 becomes the description of electrode-attached communication terminal 4 as second communication terminal 4 by interpreting the electronic device (electric vehicle 1) as the supply apparatus (charging apparatus 2). Here, communication terminal 30, communication unit 31, electrode 32, case 33, and cable 34 of first communication terminal 3 correspond to communication terminal 40, communication unit 41, electrode 42, case 43, and cable 44 of second communication terminal 4, respectively. Ground terminal 35 and cable 36 of first communication terminal 3 corresponds to ground terminal 45 and cable 46 of second communication terminal 4, respectively. Transmitting circuit 311, receiving circuit 312, controller 313, power supply circuit 314, feeding connection terminal 315, and connector 341 correspond to transmitting circuit 411, receiving circuit 412, controller 413, power supply circuit 414, feeding connection terminal 415, and connector 441, respectively. Ground connection terminal 316 and cable 361 corresponds to ground connection terminal 416 and cable 461. As described above, the destination terminal for second communication terminal 4 is first communication terminal 3.

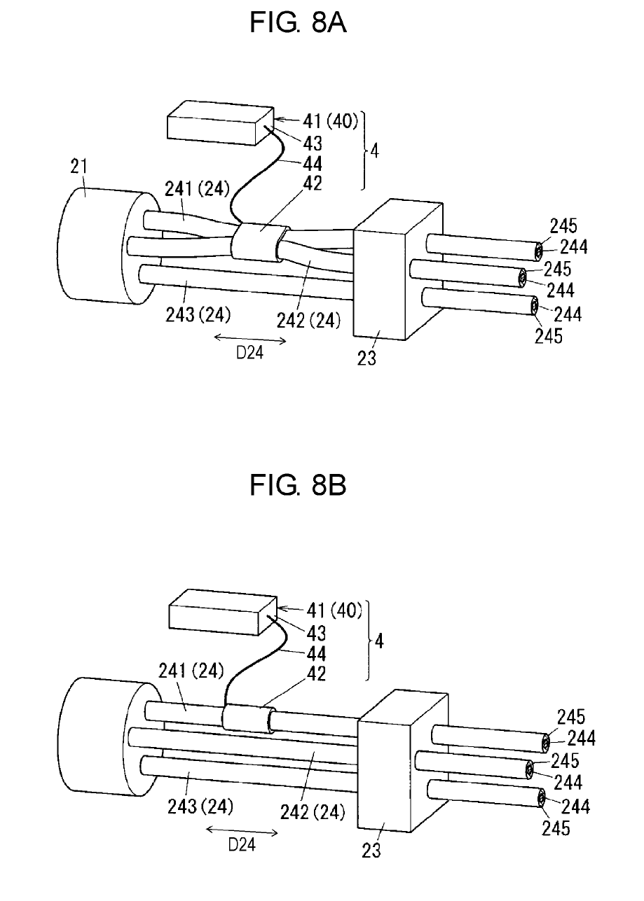

FIG. 8A is a perspective view of a main part of one example of the installed state of the second communication terminal according to Embodiment 1. FIG. 8B is a perspective view of the main part illustrating one example of another installed state of the second communication terminal according to Embodiment 1. In the supply apparatus (charging apparatus 2), second conductor 603 electrically connected to first conductor 601 includes core wire 244 (refer to FIG. 7A) of internal wire 24 (refer to FIG. 8A) that electrically connects between charging plug socket 21 and feeding circuits 23 in the supply apparatus. Therefore, electrode 42 of electrode-attached communication terminal 4 is coupled via electric field to second conductor 603 by being wound around internal wire 24, as illustrated in FIG. 8A and FIG. 8B. Electrode 42 is wound on sheath 245 around internal wire 24 over sheath 245.

In accordance with the embodiment, electrode 42 surrounds the conductive member in an entire circumference of a circumferential direction of conductive member 60. That is, in the case that conductive member 60 (second conductor 603) includes core wire 244 of internal wire 24, electrode 42 surrounds conductive member 60 in the entire circumference of the circumferential direction in a cross-section of internal wire 24 perpendicular to extending direction D24 (lengthwise direction) of internal wire 24.

In accordance with the embodiment, since a wiring between charging apparatus 2 and electric vehicle 1 is single-phase three-wire system 100V wiring, as illustrated in FIG. 8A, internal wire 24 as conductive member 60 includes neutral line 243 of N phase and a pair of voltage lines 241 and 242 of L1 phase and L2 phase. Neutral line 243 is electrically connected, for example, to a stable potential point, such as the ground. That is, neutral line 243 is grounded. Accordingly, a voltage of neutral line 243 with respect to the ground which is a voltage between neutral line 243 and the stable potential point becomes 0 [V], whereas a voltage of each of voltage lines 241 and 242 with respect to the ground which is a voltage between the stable potential point and each of the pair of voltage lines 241 and 242 becomes 100 [V]. The voltage between one voltage line 241 (L1 phase) and neutral line 243 (N phase) becomes 100 [V]. The voltage between another voltage line 242 (L2 phase) and neutral line 243 (N phase) becomes 100 [V]. The voltage between the pair of voltage lines 241, 242 becomes 200 [V].

That is, conductive member 60 includes neutral line 243 and voltage lines 241 and 242. Electrode 42 is configured to be coupled via electric field only to voltage lines 241 and 242 out of neutral line 243 and voltage lines 241 and 242. Electrode 42 is not coupled via electric field to neutral line 243 substantially. In the example shown in FIG. 8A, electrode 42 is wound around two of three internal wires 24 (both voltage lines 241 and 242) to bundle the pair of voltage lines 241 and 242 with electrode 42. On the other hand, in the example shown in FIG. 8B, electrode 42 is wound only around one voltage line 241 out of the pair of voltage lines 241 and 242. In the example shown in FIG. 8B, electrode 42 is wound so as to adhere closely to sheath 245 with almost no gap.

Thus, electrode 42 is preferably coupled via electric field only to voltage lines 241 and 242 out of conductive member 60 excluding neutral line 243. That is, in the electric field communication, since signals are transmitted using the electric field that occurs between conductive member 60 and the reference potential point, neutral line 243 that can be the reference potential point is preferably not included in conductive member 60. Electrode 42 may be coupled via electric field to both of the pair of voltage lines 241 and 242 as illustrated in FIG. 8A, and may be coupled via electric field only to one voltage line of the pair of voltage lines 241 and 242, and may not be coupled via electric field to another voltage line, as illustrated in FIG. 8B. In comparison of these configurations, the signal reception strength is higher in the configuration shown in FIG. 8A (electrode 42 being coupled via electric field to both of the pair of voltage lines 241 and 242) than the configuration shown in FIG. 8B (electrode 42 being coupled via electric field to only one of the pair of voltage lines 241 and 242).

However, an aspect of the electric field coupling of electrodes 32 and 42 to conductive member 60 is preferably identical to each other between first communication terminal 3 and second communication terminal 4. That is, when electrode 32 of first communication terminal 3 is coupled via electric field to both of the pair of voltage lines 151 and 152 (refer to FIG. 3), electrode 42 of second communication terminal 4 is preferably coupled via electric field to both of the pair of voltage lines 241 and 242 (refer to FIG. 8A). Meanwhile, when electrode 32 of first communication terminal 3 is coupled via electric field to only one voltage line 151 (refer to FIG. 4D), electrode 42 of second communication terminal 4 is preferably coupled via electric field to only one voltage line 241 (refer to FIG. 8B). When electrodes 32 and 42 each being coupled via electric field to only one voltage line, the voltage line to which electrode 32 is coupled preferably has the sane phase as the voltage line to which electrode 42 is coupled, but may have different phases (L1 phase and L2 phase) from the voltage line to which electrode 42 is coupled.

As a function peculiar to second communication terminal 4 provided in charging apparatus 2 which is the supply apparatus, second communication terminal 4 may have a function to control feeding circuit 23 of charging apparatus 2. In this case, second communication terminal 4 can switch whether or not to supply electric power from charging apparatus 2 to electric vehicle 1 which is the electric device by, for example, switching turning on and off of switch 231 provided in feeding circuit 23. In the present exemplary embodiment, second communication terminal 4 has a function to control feeding circuit 23 of charging apparatus 2. This point will be detailed below.

Controller 413 of second communication terminal 4 controls switch 231 to switch turning on and off of switch 231 electrically connected to feeding line 7. In the case that switch 231 is an electromagnetic relay, controller 413 switches turning on and off of switch 231 by outputting a control signal to an exciting coil of switch 231. Controller 413 is configured to turn off switch 231 for a communication period for which communication unit 41 communicates with the destination terminal (first communication terminal 3). In this case, controller 413 is configured to turn on switch 231 for a period different from the communication period.

Controller 413, similarly to controller 313, is configured to mainly include an MPU, and to control communication unit 41 (transmitting circuit 411 and receiving circuit 412). Controller 413 thus recognizes whether or not communication unit 41 communicates with the destination terminal, that is, whether or not it is in the communication period currently. When determining that communication unit 41 communicates with the destination terminal, that is, it is in the communication period currently, controller 413 turns off switch 231 forcibly in response to the control signal.

Switch 231 is connected in feeding line 7 that connects power source 8 to electric vehicle 1, as described above. Connection and disconnection between power source 8 and electric vehicle 1 are switched along with switching of turning on and off of switch 231. Communication unit 41 communicates with the destination terminal while charging apparatus 2 is connected to electric vehicle 1 via charging cable 5. Therefore, for the communication period, while charging apparatus 2 is connected to electric vehicle 1 via charging cable 5, when controller 413 turns off switch 231, power source 8 is electrically disconnected from electric vehicle 1, and electric power supply from power source 8 to electric vehicle 1 is stopped. When controller 413 turns on switch 231, power source 8 is electrically connected to electric vehicle 1, and electric power from power source 8 to electric vehicle 1 is supplied.

Further, when switch 231 is turned off, while charging apparatus 2 is connected to electric vehicle 1 via charging cable 5, electric vehicle 1 is electrically disconnected from first line 71 that electrically connects power source 8 to switch 231. That is, feeding line 7 is divided into first line 71 and second line 72 with switch 231 as a boundary between lines 71 and 72. First line 71 of feeding line 7 which is on the side of power source 8 from switch 231 is electrically disconnected from second line 72 of feeding line 7 which is on the side of electric vehicle 1 from switch 231 while switch 231 is turned off. Accordingly, for the communication period for which communication unit 41 communicates with the destination terminal, electric vehicle 1 is electrically disconnected from first line 71.

Here, controller 413 continuously turns off switch 231 at least from the beginning the communication period to the end of the communication period. That is, at least for the period for which communication unit 41 communicates with the destination terminal, controller 413 continuously turns off switch 231. For the period different from the communication period (before the communication period or after the communication period), controller 413 may turn on or off switch 231.

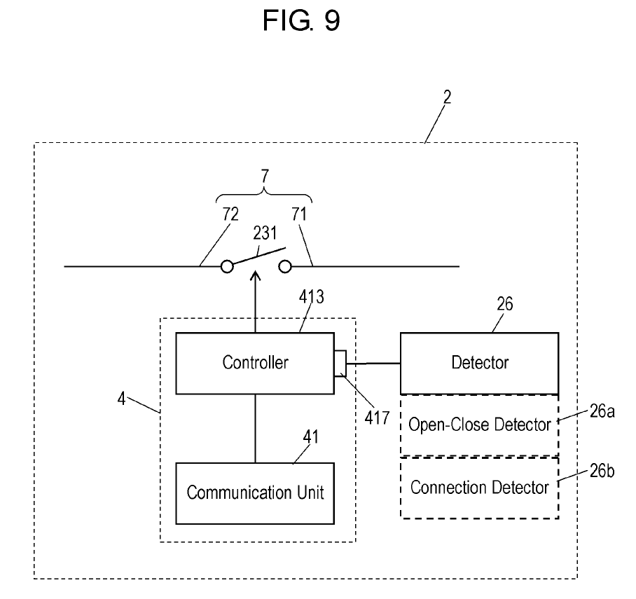

FIG. 9 is a schematic block diagram of the supply apparatus (charging apparatus 2) according to Embodiment 1. In accordance with the present embodiment, as illustrated in FIG. 9, controller 413 includes input terminal 417 electrically connected to detector 26 that is provided in charging apparatus 2 (supply apparatus) and that detects a state of charging apparatus 2. Controller 413 is configured to turn off switch 231 depending on a detection result of detector 26 input to input terminal 417 even for the period different from the communication period. In accordance with the present embodiment, detector 26 includes open-close detector 26a that detects an opening and closing state of lid 25 of charging apparatus 2.

Open-close detector 26a may be implemented by a mechanical switch turned on and off in accordance with opening and closing of lid 25, and outputs different detection results to input terminal 417 while which lid 25 is closed (hereinafter, referred to as a “closed state”) and while lid 25 is opened (hereinafter, referred to as an “open state”). FIG. 9 does not illustrate the components of second communication terminal 4 other than communication unit 41, controller 413, and input terminal 417, and does not illustrate the components of charging apparatus 2 other than switch 231 and detector 26.

When the detection result of the detector 26 indicates the open state of lid 25, controller 413 turns off switch 231 regardless of whether or not it is in the communication period currently. That is, while lid 25 is opened, controller 413 receives a detection result of detector 26 that indicates the opening of lid 25, and forcibly turns off switch 231. Accordingly, while lid 25 is opened, power source 8 is electrically disconnected from charging plug socket, and plug 51 is prevented from being plugged or unplugged while energization is performed through charging plug socket 21. Detector 26 may include not only open-close detector 26a but also connection detector 26b that detects a connection status of plug 51 of charging cable 5 to charging plug socket 21, as described above, for example.

Timing at which controller 413 turns on switch 231 will be described later (see <Operation of communication system>).

That is, communication terminal 40 is provided in the supply apparatus (charging apparatus 2) that supplies electric power from power source 8 to the electric device (electric vehicle 1) through feeding line 7, and includes controller 413 and communication unit 41 that communicates with the destination terminal (first communication terminal 3) provided in the electric device. Controller 413 controls switch 231 to switch turning on and off of switch 231 electrically connected to feeding line 7. Feeding line 7 includes first line 71 that electrically connects power source 8 to switch 231, and second line 72 that electrically connects switch 231 to the electric device.

At least one of communication unit 41 and the destination terminal is electrically connected to electrodes 32 and 42. Electrodes 32 and 42 are located away across a space from conductive member 60 included in feeding line 7 as to be coupled via electric field to conductive member 60. Communication unit 41 is configured to communicate with the destination terminal by using a transmitted signal via conductive member 60 included in second line 72 of conductive member 60 as a medium. Controller 413 is configured to turn off switch 231 for the communication period for which communication unit 41 communicates with the destination terminal.

Electrode-attached communication terminal 4 includes communication terminal 40 to which electrode 42 is added. Electrode 42 is located away via a space from conductive member 60 included in feeding line 7, so as to be coupled via electric field to conductive member 60. In electrode-attached communication terminal 4, communication unit 41 is electrically connected to electrode 42.

### <Detail of Electrode-Attached Communication Terminal>

The electrode-attached communication terminals will be detailed below.

In accordance with the embodiment, the reference potential point of communication unit 41 of second communication terminal 4 is grounded. Specifically, the reference potential point of communication unit 41 which serves as a circuit ground in transmitting circuit 411 and receiving circuit 412 is grounded, for example, by being electrically connected to a body having a stable potential that can be a reference, such as the ground, with an electric conductor. In accordance with the embodiment, similarly to first communication terminal 3, second communication terminal 4 includes ground terminal 45 functioning as a reference potential point which is to be grounded. Accordingly, communication unit 41 becomes stable because the potential of the reference potential point is identical to the potential of a stable potential point, such as the ground, providing a higher transmission efficiency than the case where the reference potential point is not grounded. In other words, since first communication terminal 3 and second communication terminal 4 transmit the transmission signal, for example, by using the electric field that occurs between conductive member 60 and the ground as described above, the stable reference potential point of communication unit 41 reduces the transmission loss and improves the transmission efficiency. The stable reference potential point of communication unit 41 reduces spurious emission.

In the present embodiment, the reference potential point of communication unit 41 is grounded via a frame ground of the supply apparatus. That is, ground terminal 45 which is the reference potential point of communication unit 41 is grounded via the frame ground of charging apparatus 2. Housing 22 of charging apparatus 2 is made of a conductive metal, and the reference potential point of feeding circuit 23 is electrically connected to housing 22. Ground terminal 45 which is the reference potential point of communication unit 41 is electrically connected to housing 22 together with the reference potential point of feeding circuit 23. Furthermore, housing 22 of charging apparatus 2 is grounded by being electrically connected to a body, such as the ground, that has a stable potential with an electric conductor. Accordingly, the reference potential point of communication unit 41 (ground terminal 45) is grounded to the body, such as the ground, that has a stable potential via housing 22 which is the frame ground of charging apparatus 2 (see FIG. 1). In charging apparatus 2, housing 22 may not necessarily have conductivity. When at least a part of housing 22 has conductivity and functions as the frame ground, the reference potential point of communication unit 41 is grounded to the body via housing 22 which is the frame ground of charging apparatus 2. This configuration allows communication unit 41 to transmit the transmission signal by using the electric field with respect to the frame ground of charging apparatus 2 (potential of housing 22). That is, end points of electric force lines that flowing from electrode 42 are converged on the frame ground of charging apparatus 2 (housing 22), which provides a stable electric field and reduces the transmission loss, hence improving the transmission efficiency and reducing spurious emission.

In accordance with the embodiment, the reference potential point of communication unit 41 is grounded together with neutral line 243. That is, internal wire 24 as conductive member 60 (second conductor 603) of charging apparatus 2 includes neutral line 243 of N phase, as described above. Accordingly, electrode-attached communication terminal 4 has a configuration in which ground electrode 45 is electrically connected to neutral line 243 and is grounded together with neutral line 243. In the case that neutral line 243 is not grounded, when an electric field (signal) is superimposed on neutral line 243, interference may occur among a plurality of charging apparatuses 2 via neutral line 243. The interference is likely to occur when the neutral line of the power source is common to charging apparatuses 2. When neutral line 243 is grounded as in the embodiment, the potential of neutral line 243 in the charging apparatuses 2 is compulsorily made uniform, and an electric field (signal) component superimposed on the neutral line decreases. Communication unit 41 can transmit the transmission signal by using the electric field that occurs between neutral line 243 and each of voltage lines 241 and 242, and a distance from a starting point to end point of the electric force line becomes short as compared with the case where the ground is the end point of the electric force line. Therefore, the electric force line becomes less susceptible to an obstacle or the like, which provides stable electric field and reduces the transmission loss, hence improving the transmission efficiency. As a distance from ground electrode 45 to a grounding point of neutral line 243 decreases and a distance from ground electrode 45 to charging apparatus 2 decreases, an effect of stable electric field increases.

In the present exemplary embodiment, also in first communication terminal 3 provided in electric vehicle 1, ground terminal 35 is grounded together with neutral line 153 similarly to second communication terminal 4 described above. That is, internal wire 15 as conductive member 60 in electric vehicle 1 (second conductor 602) includes neutral line 153 which is an N phase as described above. Therefore, ground terminal 35 is configured to be electrically connected to neutral line 153 and to be grounded together with neutral line 153. However, unlike second communication terminal 4, grounding mentioned here is electrically connected not to the ground or the like, but to conductive part 131, that is, body ground. This configuration allows communication unit 31 to transmit the transmission signal by using the electric field that occurs between neutral line 153 and each of voltage lines 151 and 152, stabilizing the electric field and reduce the transmission loss, hence improving the transmission efficiency.

Alternatively, in first communication terminal 3 provided in electric vehicle 1, ground terminal 35 may be electrically insulated from neutral line 153. This configuration provides electric insulation between neutral line 153 and conductive part 131, and maintains electric insulation between secondary battery 11 and the battery for electric parts (different from secondary battery 11 for driving). That is, in general, since conductive part 131 is electrically connected to a negative terminal of the battery for electric parts, when neutral line 153 is connected to ground terminal 35, secondary battery 11 is electrically connected to the battery for electric parts via charging circuit 14. Meanwhile, the configuration in which ground terminal 35 is electrically insulated from neutral line 153 maintains electric insulation between secondary battery 11 and the battery for electric parts. Also, in electric vehicle 1 in which neutral line 153 is not grounded, the configuration in which ground terminal 35 is electrically insulated from neutral line 153 does not require an operation for grounding neutral line 153, that is, for electrically connecting neutral line 153 to conductive part 131, thus improving workability.

### <Configuration of Communication System>

The communication system according to the present embodiment includes first communication terminal 3 and second communication terminal 4 with the above-described configurations. That is, the communication system includes first communication terminal 3 provided in the electric device, and second communication terminal 4 that is provided in the supply apparatus that supplies electric power from power source 8 to the electric device through feeding line 7, and communicates with first communication terminal 3.

At least one of first communication terminal 3 and second communication terminal 4 includes electrodes 32 and 42. That is, first communication terminal 3 includes electrode 32 while second communication terminal 4 does not include electrode 32. Alternatively, first communication terminal 3 does not include electrode 32 while second communication terminal 4 includes electrode 42. Alternatively, first communication terminal 3 includes electrode 32 while second communication terminal 4 includes 42. Electrodes 32 and 42 are located away across a space from conductive member 60 included in feeding line 7 as to be coupled via electric field to conductive member 60. Feeding line 7 includes first line 71 that electrically connects power source 8 to switch 231, and second line 72 that electrically connects switch 231 to the electric device. Ground terminal 35 is electrically connected to conductive part 131 made of a conductive material in the vehicle. Communication unit 31 is electrically connected to electrode 32 and ground terminal 35, operates with ground terminal 35 as the reference potential point, and communicates with second communication terminal 4 by using the signal transmitted via conductive member 60 as a medium.

Second communication terminal 4 includes communication unit 41 and controller 413. Communication unit 41 is configured to communicate with first communication terminal 3 by using a signal transmitted via conductive member 60 included in second line 72 of conductive member 60 as a medium. Controller 413 controls switch 231 to switch turning on and off of switch 231. Controller 413 is configured to turn off switch 231 for a communication period for which communication unit 41 communicates with first communication terminal 3.

In the present embodiment, the electric device is electric vehicle 1 including with secondary battery 11. The supply apparatus is charging apparatus 2 that supplies electric power to the electric device through the feeding line (charging cable 5), and charges secondary battery 11.

### <Operation of Communication System>

The communication system according to the present exemplary embodiment described above allows charging system 10 to perform the following operations. That is, by mutual communication between first communication terminal 3 provided in electric vehicle 1 (electric device) and second communication terminal 4 provided in charging apparatus 2 (supply apparatus), charging system 10 can exchange signals between electric vehicle 1 and charging apparatus 2.

In charging system 10, while electric vehicle 1 is electrically connected to charging apparatus 2 via charging cable 5, electric power is supplied from feeding circuit 23 of charging apparatus 2 to charging circuit 14 of electric vehicle 1, thereby charging secondary battery 11 of electric vehicle 1. In charging apparatus 2, for example, in order to perform billing according to an amount of charging or in order to determine whether electric vehicle 1 is a vehicle that is permitted to receive electric power, performing an authentication process of electric vehicle 1 is considered. Therefore, by using the communication system described above, charging system 10 can exchange signals necessary for the authenticating process of electric vehicle 1 between electric vehicle 1 and charging apparatus 2.

While charging electric vehicle 1, when electric vehicle 1 is connected via charging cable 5, charging apparatus 2 first acquires identification information from electric vehicle 1 by communication. The identification information of electric vehicle 1 is information that corresponds uniquely to electric vehicle 1, and is registered previously in first communication terminal 3 provided in electric vehicle 1. The identification information is registered, for example, by being set previously at a time of manufacturing of first communication terminal 3, or by being recorded in a memory of first communication terminal 3 with a dedicated setting device.

When electric vehicle 1 is connected to charging apparatus 2 via charging cable 5 and causes first communication terminal 3 to communicate with second communication terminal 4, first communication terminal 3 starts transmitting the identification information automatically. First communication terminal 3 repetitively transmits the identification information plural times at predetermined time intervals. Second communication terminal 4 acquires the identification information on electric vehicle 1 by receiving at least once the identification information transmitted from first communication terminal 3. That is, first communication terminal 3 is configured to transmit, to second communication terminal 4, the identification information unique to the electronic device (electric vehicle 1) by the communication with second communication terminal 4.

Upon acquiring the identification information on electric vehicle 1, second communication terminal 4 verifies the identification information against reference information previously registered. The reference information is identification information formally registered, and is previously registered in second communication terminal 4 provided in charging apparatus 2. The reference information is registered, for example, by being written in a memory of second communication terminal 4. Alternatively, in the case that second communication terminal 4 has a communication function with an authentication server, the reference information may be registered previously in the authentication server. In this case, second communication terminal 4 transmits the identification information of electric vehicle 1 to the authentication server, and then, the authentication server authenticates the identification information.

Second communication terminal 4 or the authentication server that authenticates the identification information determines that the verification is a success when the registered reference information matches with the acquired identification information. Second communication terminal 4 or the authentication server determines that the verification is a failure when the registered reference information matches with the acquired identification information. When the authentication server authenticates the identification information, the authentication server transmits information on whether the verification of the identification information succeeds or not to second communication terminal 4 as an authentication result of the identification information. Then, when the verification of the identification information succeeds, second communication terminal 4 starts supplying electric power from the supply apparatus (charging apparatus 2) to the electronic device (electric vehicle 1). On the other hand, second communication terminal 4 is configured not to cause electric power to be supplied from the supply apparatus (charging apparatus 2) to the electronic device (electric vehicle 1) when the verification of the identification information does not succeed. That is, depending on the authentication result of the identification information, second communication terminal 4 controls feeding circuit 23 of charging apparatus 2 and switches whether or not to supply electric power from charging apparatus 2 to electric vehicle 1.

Specifically, in second communication terminal 4, controller 413 controls switch 231 to switch whether or not to supply electric power from charging apparatus 2 to electric vehicle 1. When the verification of the identification information succeeds, controller 413 turns on switch 231 to cause charging apparatus 2 to supply electric power to electric vehicle 1. When controller 413 turns on switch 231, power source 8 is electrically connected to electric vehicle 1, and electric power is supplied from power source 8 to electric vehicle 1 through charging apparatus 2.

However, in the present embodiment, controller 413 is configured to turn off switch 231 for the communication period as described above. Further, controller 413 turns off switch 231 when the detection result of detector 26 indicates the open state of lid 25 even for the period different from the communication period. In this case, controller 413 turns off switch 231 when the detection result of detector 26 indicates the open state of lid 25, regardless of whether or not it is in the communication period currently. Controller 413 turns off switch 231 for the communication period regardless of the detection result of detector 26. Accordingly, at the timing when the verification of the identification information succeeds, controller 413 confirms whether or not it is in the communication period currently and further confirms the detection result of detector 26, and controls switch 231. That is, controller 413 turns on switch 231 when the verification of the identification information succeeds for a period different from a communication period and further lid 25 is in the closed state.

### <An Operation of Communication System>

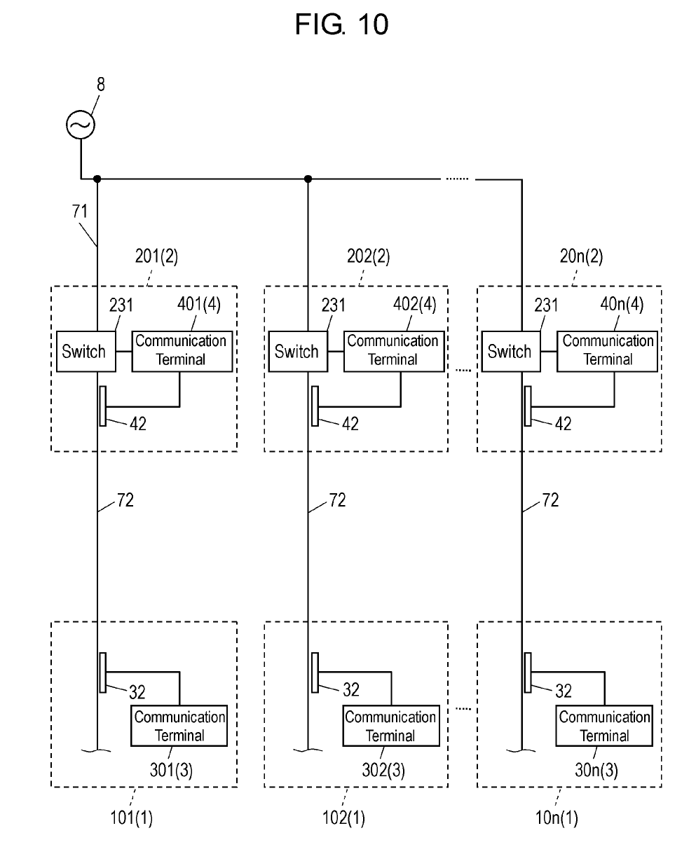

FIG. 10 is a block diagram of the communication system according to Embodiment 1 for illustrating an operation of the communication system. The communication system according to the present embodiment includes plural charging apparatuses 2 which are plural supply apparatuses. In the example illustrated in FIG. 10, n number of electric vehicles 101, 102, . . . 10n are parked in a parking lot in which n number of charging apparatuses 201, 202, . . . 20n are installed side by side. The n number of charging apparatuses 201, 202, . . . 20n have the same configurations, and each of the apparatuses is provided with second communication terminal 4 that can be a destination terminal of first communication terminal 3. Hereinafter, to distinguish second communication terminal 4 provided in charging apparatus 201 from second communication terminal 4 provided in charging apparatus 202, second communication terminal 4 of charging apparatus 201 is referred to as “second communication terminal 401”, and second communication terminal 4 of charging apparatus 202 is referred to as “second communication terminal 402”. Second communication terminal 4 provided in charging apparatus 20n is referred to as “second communication terminal 40n”. Similarly, first communication terminal 3 of electric vehicle 101 is referred to as “first communication terminal 301”, first communication terminal 3 of electric vehicle 102 is referred to as “first communication terminal 302”, and first communication terminal 3 of electric vehicle 10n is referred to as “first communication terminal 30n”.

Here, each of the n number of electric vehicles 101, 102, . . . 10n is connected to respective one of the n number of charging apparatuses 201, 202, . . . 20n in a one-to-one correspondence via second line 72 (including charging cable 5). This configuration allows each electric vehicle 1 to receive electric power supplied from corresponding charging apparatus 2. Here, each of the n number of charging apparatuses 201, 202, . . . 20n is connected to one power source 8 via respective one of first lines 71 of charging apparatuses 201, 202, . . . 20n. Accordingly, as illustrated in FIG. 10, plural (n number of) charging apparatuses 201, 202, . . . 20n are electrically connected to each other via first lines 71 of charging apparatuses 201, 202, . . . 20n.

Accordingly, while first line 71 is electrically connected to second line 72 in each of the n number of charging apparatuses 201, 202, . . . 20n, second lines 72 of the n number of charging apparatuses 201, 202, . . . 20n are electrically connected to each other through first lines 71 of charging apparatuses 201, 202, . . . 20n. Here, first communication terminal 3 and second communication terminal 4 communicate with each other by using a transmission signal transmitted via conductive member 60 included in second line 72 of conductive member 60 as a medium. Accordingly, while second lines 72 are electrically connected to each other among the n number of charging apparatuses 201, 202, . . . 20n, the transmission signal may leak among the n number of charging apparatuses 201, 202, . . . 20n. For example, the transmission signal transmitted by first communication terminal 301 of electric vehicle 101 to second communication terminal 401 of charging apparatus 201 may leak to second communication terminal 402 of charging apparatus 202 through first line 71. Further, in this case, when second communication terminal 402 of charging apparatus 202 communicates with first communication terminal 302 of electric vehicle 102, interference may occur between charging apparatus 201 and charging apparatus 202.

The interference mentioned here means a phenomenon in which signals (transmission signals) from plural electric vehicles 1 (first communication terminals 3) mix, and plural charging apparatuses 2 (second communication terminals 4) cannot receive the signals normally. For example, in the above example, charging apparatus 202 may receive the signal from electric vehicle 102 and the signal that leaks from electric vehicle 101 through first line 71 simultaneously. In this case, charging apparatus 202 may not determine which signal is from corresponding electric vehicle 102, that is, the signal from electric vehicle 102 connected to second line 72. That is, the interference occurs. When such interference occurs, for example, when attempting to acquire the identification information by communication from electric vehicle 1, charging apparatus 202 acquires the identification information of two electric vehicles 101 and 102 simultaneously.

In the communication system according to the present embodiment, as described above, controller 413 turns off switch 231 for the communication period, thereby preventing such leakage of the transmission signal and occurrence of interference. That is, when switch 231 is turned off, first line 71 on the side of power source 8 from switch 231 is electrically disconnected from second line 72 on the side of electric vehicle 1 from switch 231 while switch 231 is turned off. Controller 413 turns off switch 231 to disconnect first line 71 from second line 72 for the communication period for which first communication terminal 3 and second communication terminal 4 communicate with each other. For example, during communication between first communication terminal 301 and second communication terminal 401, controller 413 of second communication terminal 401 turns off switch 231 of charging apparatus 201, thereby disconnecting second line 72 between charging apparatus 201 and electric vehicle 101 from first line 71. Therefore, the transmission signal transmitted by first communication terminal 301 to second communication terminal 401 is prevented from leaking to second communication terminal 402 through first line 71, thereby and occurrence of interference between charging apparatus 201 and charging apparatus 202 is inhibited. For the period different from the communication period, communication terminal 40n may turn on switch 231, whereby first line 71 and second line 72 are connected to each other and electric power is supplied to electric vehicle 10n.

### <Advantageous Effects>

In the configuration using wireless communications as described in PTL 2, when plural devices that can be communication partners exist near one device, it is difficult to perform one-to-one communication. For example, when two electric vehicles approach one charging apparatus, both of the two electric vehicles can communicate with the charging apparatus, and thus, it is difficult for the charging apparatus to identify which of the two electric vehicles is to be charged.

Electrode-attached communication terminal 3a, communication terminal 30, and the communication system according to the present exemplary embodiment described above can perform electric field communication with the destination terminal by using conductive member 60 as a medium with the destination terminal and exchanging signals. Since the electric field communication mentioned here mainly uses the electric field that attenuates in proportion to the third power of a distance when propagating through space, communication can be established between terminals connected via a particular communication path instead of an unspecified path in space, although non-contact. That is, in the electric field communication, since the signal that propagates through space immediately attenuates and the signal propagates mainly through conductive member 60 with little attenuation, communication between terminals connected via the particular communication path is established. Therefore, conductive member 60 as the communication path allows electrode-attached communication terminal 3 to establish communication with the destination terminal only after the electronic device is connected to the supply apparatus via feeding line 7 (second line 72). This results in an advantage that one-to-one communication can be performed even when the supply apparatus and the electric device exist within a short distance with a one-to-many or plural-to-one relationship.

Moreover, since electrode 32 is coupled via electric field to conductive member 60, for example, electrode 32 can positively superimpose the electric field component of the transmission signal applied by transmitting circuit 311 on second conductor 602 or first conductor 601. Since electrode 32 is coupled via electric field to conductive member 60 by being wound on the sheath around internal wire 15 or charging cable 5, electrode-attached communication terminal 3a can be easily installed in the electronic device by post-installation. That is, since electrode 32 is coupled via electric field to the medium (conductive member 60), electrode-attached communication terminal 3a can communicate even if electrode 32 is not directly connected to the medium, and can be easily installed by post-installation. Since it is unnecessary to process internal wire 15 or charging cable 5 for installing electrode 32, electrode-attached communication terminal 3a once installed can be moved. Alternatively, even when electrode-attached communication terminal 3a is installed to the electronic device from the beginning (at the time of manufacturing of the electronic device), electrode-attached communication terminal 3a which requires neither soldering nor special connectors reduces installation costs or time and effort.

Effects as described above can be produced not only in electrode-attached communication terminal 3 and communication terminal 30, but also in electrode-attached communication terminal 4 and communication terminal 40 having the identical basic configuration.

In the present embodiment, as a function peculiar to second communication terminal 4 provided in charging apparatus 2 which is the supply apparatus, second communication terminal 4 has a function to control feeding circuit 23 of charging apparatus 2. That is, controller 413 of second communication terminal 4 controls switch 231 to switch turning on and off of switch 231 electrically connected to feeding line 7. Controller 413 is configured to turn off switch 231 for the communication period for which communication unit 41 communicates with the destination terminal (first communication terminal 3). In this configuration, for the communication period for which first communication terminal 3 and second communication terminal 4 communicate with each other, controller 413 turns off switch 231, thereby first line 71 is electrically disconnected from second line 72. In other words, while first line 71 is electrically connected to second line 72, first communication terminal 3 and second communication terminal 4 do not communicate with each other.

Therefore, although first communication terminal 3 and second communication terminal 4 communicate with each other by using a transmission signal transmitted via conductive member 60 included in second line 72 of conductive member 60 as a medium, switch 231 prevents leakage of the transmission signal to first line 71. As a result, for example, even when plural charging apparatuses 2 are electrically connected to each other via first line 71 as in the operation example described above, plural charging apparatuses 2 are electrically disconnected from each other, substantially, by turning off switch 231. This configuration prevents interference among plural charging apparatuses 2.

The interference mentioned here, as described above, means a phenomenon in which signals (transmission signals) from plural electric vehicles 1 (first communication terminals 3) mix, and plural charging apparatuses 2 (second communication terminals 4) cannot receive the signals normally. That is, in the configuration of the present embodiment, plural charging apparatuses 2 are electrically disconnected from each other, substantially, by turning off switch 231, and the communication paths for the electric field communication between plural charging apparatuses 2 are disconnected. Accordingly, when there are plural pairs of charging apparatus 2 and electric vehicle 1 connected to each other via second line 72, each pair is electrically independent, and occurrence of interference among plural charging apparatuses 2 is inhibited. Since the interference is likely to be problematic as a number of charging apparatuses 2 connected to one power source system (first line 71) increases, the effect of the present exemplary embodiment increases in which occurrence of interference can be inhibited as the number of charging apparatuses 2 connected to one power source increases.

Switch 231 is not limited to the electromagnetic relay, and may be implemented by a semiconductor switching device, such as a P-intrinsic-N (PIN) diode or a field effect transistor (FET) using gallium arsenide (GaAs). However, switch 231 is preferably implemented by a mechanical switch, such as the electromagnetic relay, in which contacts are mechanically opened and closed to be turned on and off. That is, unlike general wired communication, since the electric field communication mainly uses the electric field, isolation performance of switch 231 to the signal when switch 231 is turned off is higher in the mechanical switch than in the semiconductor switching device. Accordingly, in the case that switch 231 is implemented by the mechanical switch, the signal disconnection effect between the plural charging apparatuses 2 increases more than a semiconductor switching device.

In the electric field communication, a signal component that propagates through space attenuates in proportion to the third power of the distance. Accordingly, even when leakage of the signal occurs by propagation through space, influence on the interference of the leakage signal is very small, and the effect of inhibiting the interference by turning off switch 231 is sufficient. In fact, the signal leaked by propagating through space between plural charging apparatuses 2 attenuates at more than about 20 [dB], that is, about 1/100 with respect to signal electric power.

In the configuration of the present embodiment, noise that flows from first line 71 into second communication terminal 4 is reduced. That is, when switch 231 is turned off to electrically disconnect first line 71 from second line 72, the noise that flows from first line 71 to second communication terminal 4 is reduced. For example, in the operation example described above, while charging apparatus 201 charges electric vehicle 101, an AC-DC converter in charging circuit 14 of electric vehicle 101 generates noise, and the noise may be transmitted to first line 71 via charging apparatus 201. In this case, switch 231 of charging apparatus 202 connected to the same first line 71 as charging apparatus 201 is turned off to prevent the noise on first line 71 from flowing into second communication terminal 402 of charging apparatus 202. Further, when first line 71 is electrically connected to various devices via a switchboard or the like, switch 231 of charging apparatus 2 is turned off to prevent the noise generated in these various devices from flowing into second communication terminal 4 of charging apparatus 2 via first line 71. The noise that flows from first line 71 into second communication terminal 4 is reduced in this way, thereby reducing influence of the noise on communication between first communication terminal 3 and second communication terminal 4.

Furthermore, switch 231 of charging apparatus 2 is turned off to prevent first communication terminal 3 or second communication terminal 4 itself from becoming a noise source. That is, since first communication terminal 3 and second communication terminal 4 each output predetermined electric power during communication, the electric power may become noise. Switch 231 of charging apparatus 2 is turned off to prevent the noise from flowing into first line 71, and reduces influence of the noise on various devices and other charging apparatus 2 (second communication terminal 4) connected to first line 71. The influence of the noise mentioned here, unlike the interference described above, includes a case where electric field communication itself is prevented between other charging apparatus 2 (second communication terminal 4) and electric vehicle 1 (first communication terminal 3).

Furthermore, ground terminal 35 which is the reference potential point of communication unit 31 is electrically connected (grounded) to conductive part 131 of electric vehicle 1. In other words, ground terminal 35 connected to conductive part 131 allows communication unit 31 to be grounded to the body. This configuration reduces impedance of the reference potential point of communication unit 31 as compared with a case where ground terminal 35 is not electrically connected to conductive part 131 (electrically isolated), thus stabilizing potential of the reference potential point. This provides stable electric field near electrode 32 and reduces the transmission loss, thus improving the transmission efficiency. In the communication between first communication terminal 3 and second communication terminal 4, electric field communication that mainly uses the electric field becomes more dominant. This configuration reduces electromagnetic waves that do not propagate through second conductor 602 or first conductor 601 and are emitted to space, hence reducing spurious emission. This results in an advantage of stable electric field used for the electric field communication, improving the transmission efficiency of the transmission signal and reducing spurious emission.

That is, while electrode-attached communication terminal 3 communicates with the destination terminal, when communication unit 31 applies a signal to electrode 32, for example, an electric field occurs between conductive member 60 and the ground, as described above. At this moment, if ground terminal 35 is not connected to conductive part 131, any of conductive part 131 that exists near electrode 32, neutral line 153, and the ground can be the end points of the electric force lines that start from electrode 32, which may lead to unstable electric field. Meanwhile, when ground terminal 35 which is the reference potential point of communication unit 31 is connected to conductive part 131, the end points of the electric force lines that start from electrode 32 is converged on conductive part 131. This configuration stabilizes electric field used for the electric field communication and improves the signal transmission efficiency. Also, as a surface area of conductive part 131 increases, the effect produced by connecting ground terminal 35 to conductive part 131 increases. This is caused by inhibiting a ground bounce generated from an electric field coupling portion.

The following will describe a result of confirmation about to what extent the transmission efficiency is improved during transmission of the transmission signal from first communication terminal 3 to second communication terminal 4, by electrically connecting ground terminal 35 which is the reference potential point of communication unit 31 to conductive part 131 actually. Ground terminal 35 connected to conductive part 131 significantly reduces the transmission loss and improves the transmission efficiency, as compared with a case where ground terminal 35 is not connected to conductive part 131. In a certain vehicle model, while the transmission loss in a case where ground terminal 35 is not connected to conductive part 131 is 50 [dB] while the transmission loss in a case where ground terminal 35 is connected to conductive part 131 is 20 [dB]. In other vehicle models, ground terminal 35 connected to conductive part 131 improves the transmission loss, for example, from 55 [dB] to 40 [dB], or improves the transmission loss from 50 [dB] to 35 [dB].

In the present embodiment, ground terminals 35 and 45 are not essential for electrode-attached communication terminals 3 and 4, and ground terminals 35 and 45 may be omitted if appropriate. When ground terminals 35 and 45 are omitted in communication terminals 30 and 40, ground connection terminals 316 and 416 may be omitted.

In the communication system according to the present exemplary embodiment, the electric device is electric vehicle 1 equipped with secondary battery 11, and the supply apparatus is charging apparatus 2. Charging apparatus 2 supplies electric power to the electric device through the feeding line (charging cable 5), and charges secondary battery 11. This configuration allows the communication system to perform the communication between electric vehicle 1 and charging apparatus 2 in charging system 10. Therefore, in charging system 10, for example, in order to perform billing according to an amount of charging, or in order to determine whether or not electric vehicle 1 is a vehicle to which charging is permitted, the authentication process of electric vehicle 1 can be performed.

Moreover, since communication with the destination terminal is established only after the electric device and the supply apparatus are connected to each other via the feeding line (charging cable 5), even when plural charging apparatuses 2 are installed side by side, electrode-attached communication terminal 3 can perform one-to-one communication between electric vehicle 1 and charging apparatus 2. Even when plural electric vehicles 1 are positioned near one charging apparatus 2, one-to-one communication between electric vehicle 1 and charging apparatus 2 can be performed. As a result, this communication system can perform one-to-one communication even when plural devices that can be communication partners exist near the one device.

Here, as in the present embodiment, first communication terminal 3 is preferably configured to transmit, to second communication terminal 4, the identification information unique to the electric device (electric vehicle 1) by communication with second communication terminal 4. Accordingly, for example, in order to perform billing according to the amount of charging, or in order to determine whether or not electric vehicle 1 is a vehicle to which charging is permitted, the authentication process of electric vehicle 1 can be performed by using the identification information transmitted from first communication terminal 3 to second communication terminal 4.

Second communication terminal 4 is configured not to cause the supply apparatus (charging apparatus 2) to supply electric power to the electric device (electric vehicle 1) when the verification of the identification information does not succeed. Therefore, when the verification of the identification information does not succeed due to a device other than authorized electric vehicle 1 connected or other reasons, charging apparatus 2 does not supply electric power, preventing useless electric power supply to an unauthorized device.

Electric vehicle 1 is used as the electric device in the communication system, and includes first communication terminal 3. Therefore, even when plural devices (charging apparatuses 2) that can be communication partners exist near one electric vehicle 1, electric vehicle 1 can perform one-to-one communication with charging apparatus 2 actually connected via charging cable 5.

Charging apparatus 2 is used as the supply apparatus in the communication system, and includes second communication terminal 4. Therefore, even when plural devices (electric vehicles 1) that can be communication partners exist near one charging apparatus 2, charging apparatus 2 can perform one-to-one communication with electric vehicle 1 actually connected via charging cable 5.

The electric device is not limited to electric vehicle 1, and the supply apparatus is not limited to charging apparatus 2. That is, the electric device may have a configuration that receives electric power supplied from the supply apparatus through a feeding line, and the electric device may be a device, such as a smart phone, a tablet terminal, or a digital camera, including a secondary battery.

### Exemplary Embodiment 2

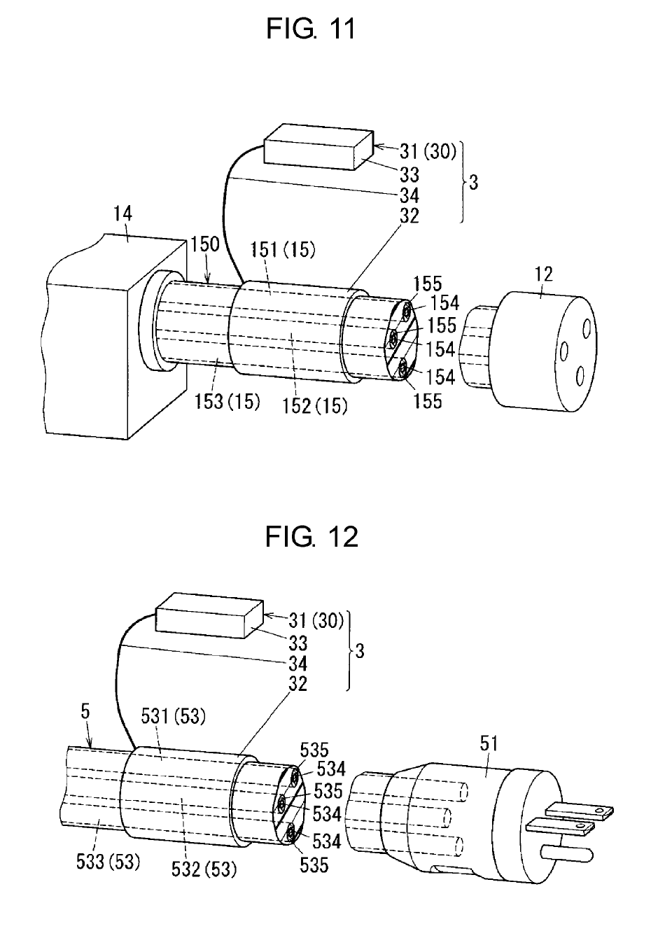

FIG. 11 is a perspective view of a main part of a first communication terminal according to Embodiment 2 for illustrating one example of an installation state thereof. An electrode-attached communication terminal according to the embodiment is different from the electrode-attached communication terminal according to Embodiment 1 in a coupling state of electrode 32 to conductive member 60. Hereinafter, components identical to those of Embodiment 1 are denoted by the same reference numerals, and their description will be omitted.

In accordance with the embodiment, electrode 32 of electrode-attached communication terminal 3 (a first communication terminal) provided in electric vehicle 1 (a vehicle) is configured to be coupled via electric field to all of neutral line 153 and voltage lines 151 and 152, as illustrated in FIG. 11. That is, according to the embodiment, similarly to Embodiment 1, conductive member 60 includes neutral line 153 and voltage lines 151 and 152. While electrode 32 is coupled via electric field only to voltage lines 151 and 152 out of neutral line 153 and voltage lines 151 and 152 in accordance with Embodiment 1, electrode 32 is coupled via electric field to all of neutral line 153 and voltage lines 151 and 152 in accordance with the present embodiment.

In accordance with the present embodiment, in detail, as internal wire 15 of electric vehicle 1, one pair of voltage lines 151 and 152 which are an L1 phase and an L2 phase, and neutral line 153 which is an N phase constitute one internal cable 150. That is, internal cable 150 includes three internal wires 15 in total including the pair of voltage lines 151 and 152 and neutral line 153 which are covered with an insulating sheath (an outer covering) and bundled into one cable. Accordingly, in the vehicle (electric vehicle 1), one internal cable 150 electrically connects charging inlet 12 to charging circuit 14. As illustrated in FIG. 11, electrode 32 performs electric field coupling to conductive member 60 (second conductor 602) by being wound on the sheath around internal cable 150 without processing internal cable 150.

The configuration of the present exemplary embodiment described above allows electrode 32 to be installed over the outer covering (sheath) of internal cable 150 even when plural internal wires 15 are bundled and constitute the cable (internal cable 150) inside the vehicle (electric vehicle 1). Therefore, an operator who installs electrode-attached communication terminal 3 allows electrode 32 to be coupled via electric field to core wire 154 of internal wire 15 as second conductor 602 without processing internal cable 150, and post-installation in electric vehicle 1 is easy.

In the configuration of the present embodiment, an effect is especially increased produced by ground terminal 35 of first communication terminal 3 provided in electric vehicle 1 being grounded together with neutral line 153. That is, as in the present exemplary embodiment, in the configuration in which electrode 32 of first communication terminal 3 provided in electric vehicle 1 is coupled via electric field to neutral line 153, an electric field occurs between neutral line 153 and the ground. In charging apparatus 2 provided with second communication terminal 4, neutral line 243 is grounded. Accordingly, a region with an unstable electric field may exist in a communication path between first communication terminal 3 and second communication terminal 4. In this configuration, ground terminal 35 grounded (body ground) together with neutral line 153 decreases impedance of a reference potential point of communication unit 31 and provides stable electric field, thus significantly improving transmission efficiency.

In the configuration of the present exemplary embodiment, as described in the first exemplary embodiment, an effect provided by a reference potential point of communication unit 41 being grounded together with neutral line 243 increases. This is because interference among plural charging apparatuses 2 described above occurs conspicuously in a portion of conductive member 60 that is coupled via electric field to electrode 42 due to an electric field (signal) more positively superimposed on neutral line 243. That is, in the configuration of the present exemplary embodiment, the reference potential point of communication unit 41 is grounded together with neutral line 243 to reduce an electric field (signal) component superimposed on neutral line 243 and significantly prevent interference among plural charging apparatuses 2.

Other configurations and functions are similar to configurations and functions of the first exemplary embodiment.

### Exemplary Embodiment 3

FIG. 12 is a perspective view of a main part of a first communication terminal according to Exemplary Embodiment 3 for illustrating an example of an installation state thereof. An electrode-attached communication terminal according to the present embodiment is different from the electrode-attached communication terminal according to Embodiment 1 in a coupling state of electrode 32 to conductive member 60. Hereinafter, components identical to those of the terminal according to Embodiment 1 are denoted by the same reference numerals, and their description will be omitted.

In the present exemplary embodiment, as illustrated in FIG. 12, electrode 32 of electrode-attached communication terminal 3 (a first communication terminal) provided in electric vehicle 1 (an electronic device) is coupled via electric field to core wire 534 of electric wire 53 included in charging cable 5, first conductor 601. In the present exemplary embodiment, similarly to Embodiment 1, conductive member 60 includes neutral line 533 and voltage lines 531 and 532. In the present exemplary embodiment, electrode 32 is coupled via electric field to all of neutral line 533 and voltage lines 531 and 532 similarly to Embodiment 2.

In detail, charging cable 5 includes neutral line 533 which is an N phase and one pair of voltage lines 531 and 532 which are an L1 phase and an L2 phase which are bundled into one cable with an insulating sheath (outer covering) thereon. Accordingly, one charging cable 5 electrically connects the electronic device (electric vehicle 1) to the supply apparatus (charging apparatus 2). As illustrated in FIG. 12, electrode 32 performs electric field coupling to conductive member 60 (first conductor 601) by being wound on the sheath around charging cable 5 without processing charging cable 5.

The configuration of the present exemplary embodiment described above allows electrode 32 to be installed to charging cable 5, which is the feeding line, over the outer covering (sheath). Therefore, an operator who installs electrode-attached communication terminal 3 can cause electrode 32 to be coupled via electric field to core wire 534 of electric wire 53 as first conductor 601 without processing charging cable 5.

The configuration in which electrode 32 is installed to charging cable 5 as described in the present exemplary embodiment is particularly useful in electric vehicle 1 with the configuration in which charging cable 5 is not detachable. That is, electric vehicle 1 may lack charging inlet 12 to which connector 52 of charging cable 5 is detachably connected and employ the configuration in which charging cable 5 is electrically connected to charging circuit 14 directly. In electric vehicle 1 with such a configuration, charging cable 5 is accommodated inside car body 13 except when secondary battery 11 is charged, and when secondary battery 11 is charged, charging cable 5 is pulled out of car body 13 and is connected to charging apparatus 2. In electric vehicle 1 with such a configuration, charging cable 5 is typically provided at a position where a user of electric vehicle 1 can touch, hence simplifying an operation of installing electrode 32 to charging cable 5.

The configuration of the present exemplary embodiment is applicable not only to first communication terminal 3 but also to second communication terminal 4. That is, electrode 42 of electrode-attached communication terminal 4 (a second communication terminal) provided in charging apparatus 2 (the supply apparatus) may be coupled via electric field to core wire 534 of electric wire 53 included in charging cable 5, which is first conductor 601. This configuration is particularly useful in charging apparatus 2 with the configuration in which charging cable 5 is not detachable. That is, charging apparatus 2 may lack charging plug socket 21 to which plug 51 of charging cable 5 is detachably connected and employ the configuration in which charging cable 5 is electrically connected to feeding circuit 23 directly. In this kind of charging apparatus 2, charging cable 5 is typically provided at a position where a user of charging apparatus 2 can touch, hence particularly simplifying an operation of installing electrode 42 in charging cable 5.

Other configurations and functions are similar to configurations and functions of Embodiment 1.

### Exemplary Embodiment 4

A communication system according to Exemplary Embodiment 4 is different from the communication system according to Embodiment 1 in that only one of first communication terminal 3 and second communication terminal 4 includes electrode 32 (or 42) coupled via electric field to conductive member 60. Components identical to those of the terminal according to Embodiment 1 are denoted by the same reference numerals, and their description will be omitted.

The present exemplary embodiment describes an example in which, only first communication terminal 3 provided in electric vehicle 1 (an electric device) out of first communication terminal 3 and second communication terminal 4 includes electrode 32. In the present embodiment, in second communication terminal 4 provided in charging apparatus 2 (a supply apparatus), communication unit 41 is electrically connected directly to conductive member 60 (at least one of first conductor 601 and second conductor 603).

In this configuration, between first communication terminal 3 and second communication terminal 4, only electrode 32 of first communication terminal 3 and conductive member 60 are coupled to each other while not contacting each other, and except for this coupling, a communication path is configured to be directly connected via conductive member 60. This results in a smaller transmission loss between first communication terminal 3 and second communication terminal 4 than a case where both electrode 32 of first communication terminal 3 and electrode 42 of second communication terminal 4 are coupled to conductive member 60 while not contacting each other. That is, for example, in the case that charging apparatus 2 includes second communication terminal 4 from the beginning (at a time of manufacturing of the device), post-installation of second communication terminal 4 in the device (charging apparatus 2) is not needed. The configuration of the present exemplary embodiment reduces the transmission loss.

In this configuration, since electrode 32 of first communication terminal 3 provided in electric vehicle 1 is coupled to conductive member 60 while not contacting, electric vehicle 1 does not necessarily include first communication terminal 3 from the beginning (at the time of manufacturing of the electric vehicle). Also, processing for installing electrode 32 around a feeding line through which a large electric current flows in electric vehicle 1 is not necessary, hence simplifying an operation for installation of first communication terminal 3 and reducing a cost of electric vehicle 1. In particular, for a two-wheel vehicle or the like which is relatively inexpensive among electric vehicles 1, the effect of cost reduction of electric vehicle 1 is large. Also, first communication terminal 3 can be easily installed in vehicles that have already appeared on the market by post-installation, and is applicable to a lot of vehicle models without involving system changes.

The configuration of the present exemplary embodiment is not limited to the above-described example. Only second communication terminal 4 out of first communication terminal 3 and second communication terminal 4 which is provided in charging apparatus 2 (a supply apparatus) may include electrode 42. In this case, in first communication terminal 3 provided in electric vehicle 1 (an electric device), communication unit 31 is electrically connected directly to conductive member 60 (at least one of first conductor 601 and second conductor 602).

In this configuration, between first communication terminal 3 and second communication terminal 4, only electrode 42 of second communication terminal 4 is coupled to conductive member 60 while not contacting conductive member 60, and except for this coupling, a communication path is to be formed that is directly connected via conductive member 60. This results in a smaller transmission loss between first communication terminal 3 and second communication terminal 4 than a case where both electrode 32 of first communication terminal 3 and electrode 42 of second communication terminal 4 are coupled to conductive member 60 while not contacting. That is, for example, in the case that electric vehicle 1 includes first communication terminal 3 from the beginning (at a time of manufacturing of the device), post-installation of first communication terminal 3 in the device (electric vehicle 1) is not needed, and thus employment of the configuration of the present exemplary embodiment reduces the transmission loss.

Other configurations and functions are similar to configurations and functions of Embodiment 1. Also, the configuration of the present exemplary embodiment is applicable in combination with the configuration of each of Embodiments 2 and 3, in addition to the configuration of Embodiment 1.

### Exemplary Embodiment 5

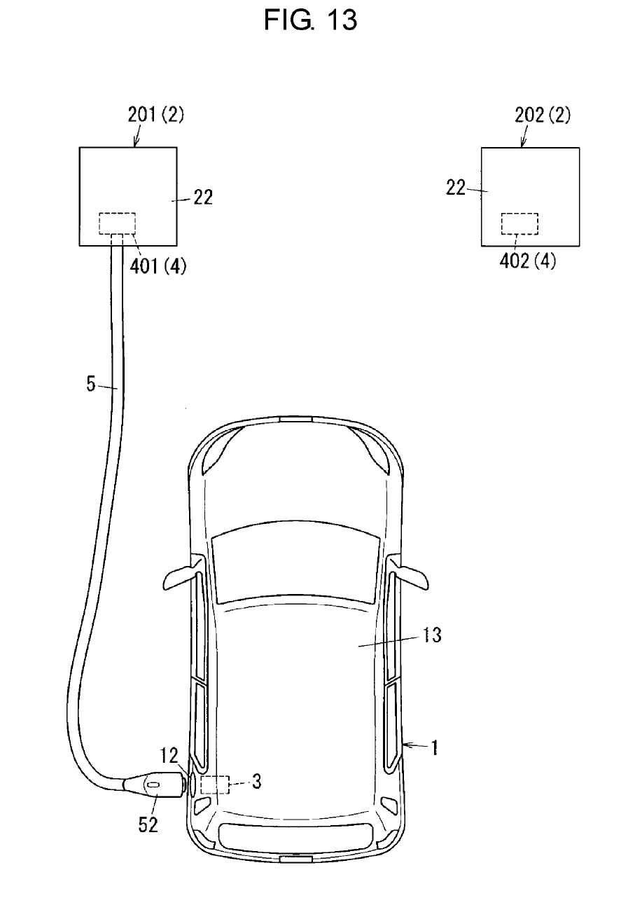

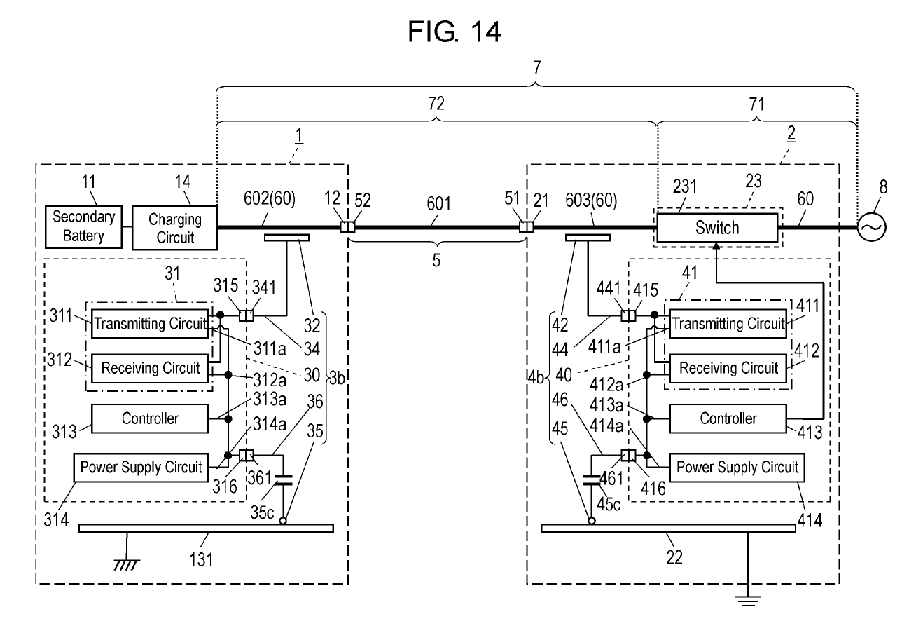

FIG. 13 is a plan view illustrating an electric vehicle and charging apparatus that use a communication system according to Exemplary Embodiment 5. The communication system according to the present exemplary embodiment is different from the communication system according to Embodiment 1 in that communication unit 31 has a function to adjust transmission strength of a signal (transmission signal) so as to prevent interference among plural charging apparatuses 2. Hereinafter, components identical to those of the terminal according to Embodiment 1 are denoted by the same reference numerals, and their description will be omitted.

In the present exemplary embodiment, as illustrated in FIG. 13, plural charging apparatuses 2 which are supply apparatuses are installed side by side. In the example illustrated in FIG. 13, as the plural supply apparatuses, two charging apparatuses 2, which are charging apparatus 201 (2) as a first supply apparatus and charging apparatus 202 (2) as a second supply apparatus, are installed side by side. Electric vehicle 1 which is an electric device is configured to receive electric power supplied from the first supply apparatus (charging apparatus 201) of the plural supply apparatuses (charging apparatuses 201 and 202).

That is, the present exemplary embodiment assumes a situation in which electric vehicle 1 is parked in a parking lot in which plural charging apparatuses 201 and 202 are installed side by side. In this situation, electric vehicle 1 is connected via charging cable 5 to charging apparatus 201 (first supply apparatus) which is one of plural charging apparatuses 201, 202. This configuration allows electric vehicle 1 to receive electric power supplied from charging apparatus 201 (first supply apparatus) connected via charging cable 5. Charging apparatus 201 which is the first supply apparatus and charging apparatus 202 which is the second supply apparatus are, for example, installed adjacent to each other, and have the same configuration as each other. Each of the apparatuses is provided with second communication terminal 4 that can be a destination terminal of first communication terminal 3. Hereinafter, to distinguish second communication terminal 4 provided in charging apparatus 201 from second communication terminal 4 provided in charging apparatus 202, second communication terminal 4 of charging apparatus 201 is referred to as “second communication terminal 401”, and second communication terminal 4 of charging apparatus 202 is referred to as “second communication terminal 402”.

Here, communication unit 31 of first communication terminal 3 provided in electric vehicle 1 adjusts the transmission strength of the transmission signal to cause radiated electromagnetic field strength to be equal to or less than a predetermined value in second supply apparatus (charging apparatus 202) different from first supply apparatus (charging apparatus 201) of the plural supply apparatuses. The following details a reason therefor.

Ground terminal 35 which is a reference potential point of communication unit 31 electrically connected to conductive part 131 improves transmission efficiency via electric field communication using conductive member 60 as a medium; however, this may simultaneously increase a radiated electromagnetic field that is output from communication unit 31 and propagates through space. This radiated electromagnetic field may also reach charging apparatus 202 to which electric vehicle 1 is not connected (second supply apparatus). When second communication terminal 402 provided in charging apparatus 202 receives this radiated electromagnetic field, interference occurs between charging apparatus 201 and charging apparatus 202. Therefore, in the present exemplary embodiment, communication unit 31 is configured to prevent interference by adjusting the transmission strength of the transmission signal as to cause the radiated electromagnetic field strength in charging apparatus 202 to be equal to or less than the predetermined value.

In more detail, communication unit 31 adjusts the transmission strength (transmission power) of the transmission signal in transmitting circuit 311 as to cause the radiated electromagnetic field strength near electrode 42 of second communication terminal 402 in charging apparatus 202, which is a second supply apparatus, to be equal to or less than the predetermined value. This configuration allows charging apparatuses 201 and 202 to isolate the transmission signal from electric vehicle 1 connected via charging cable 5 (hereinafter referred to as “desired signal”) from a transmission signal from electric vehicle 1 that is not connected (hereinafter referred to as “leakage signal”). This prevents interference between plural charging apparatuses 2.

Here, the predetermined value that is an upper limit of the radiated electromagnetic field strength in second communication terminal 402 may be previously determined and stored in a memory of second communication terminal 402, and may be a value that changes in response to an operation of a variable resistor or the like. The predetermined value may be 10 [dBμV/m]. Example 1 and Example 2 of the predetermined value of the present exemplary embodiment will be described below.

### EXAMPLE 1

In Example 1, the predetermined value is determined as to cause reception strength of the transmission signal (reception power) in second communication terminal 402 provided in charging apparatus 202 (second supply apparatus) to be smaller than reception strength in second communication terminal 401 provided in charging apparatus 202 (first supply apparatus). This configuration produces a difference in the reception strength of the transmission signal transmitted from first communication terminal 3 between charging apparatus 201 and charging apparatus 202. In other words, a value obtained by converting the radiated electromagnetic field strength near second communication terminal 402 of charging apparatus 202 into the reception strength of the transmission signal in second communication terminal 402 becomes lower than the reception strength of the transmission signal in second communication terminal 401. An antenna gain of electrode 42 may be reflected on the converted value.

In this case, second communication terminal 4 can distinguish the desired signal from the leakage signal, for example, by comparing the reception strength of the transmission signal with a predetermined threshold. That is, by determining that the transmission signal is the desired signal when the reception strength of the transmission signal is equal to or higher than the threshold, and by determining that the transmission signal is the leakage signal when the reception strength is lower than the threshold, second communication terminal 4 can extract only the desired signal, thereby suppressing interference.

Also, comparing the transmission signal received by second communication terminal 401 with the transmission signal received by second communication terminal 402 also allows the desired signal to be distinguished from the leakage signal. In this case, for example, a higher level apparatus capable of communicating with both second communication terminals 401 and 402 compares the reception strength of the transmission signal between both second communication terminals 401 and 402. That is, when second communication terminal 401 and second communication terminal 402 receive the signal transmitted from one electric vehicle 1 simultaneously, the higher level apparatus compares the reception strength of the transmission signal in second communication terminal 401 with the reception strength of the transmission signal in second communication terminal 402. Then, the higher level apparatus determines that second communication terminal 4 with the higher reception strength receives the desired signal, and that second communication terminal 4 with the lower reception strength receives the leakage signal, thereby suppressing interference.

In this configuration, since a difference only needs to arise in the reception strength of the transmission signal between charging apparatus 201 and charging apparatus 202, communication unit 31 of first communication terminal 3 can set relatively high transmission strength of the transmission signal. Therefore, Example 1 provides relatively high reception strength of the transmission signal (desired signal) in second communication terminal 401 and high transmission efficiency between electric vehicle 1 and charging apparatus 201 which are connected via charging cable 5.

### EXAMPLE 2

In Example 2, the predetermined value is set to cause the reception strength of the transmission signal in second communication terminal 402 provided in charging apparatus 202 (second supply apparatus) to be lower than reception sensitivity of second communication terminal 402. The reception sensitivity mentioned here is the minimum reception strength that allows second communication terminal 402 to secure reception quality required for communication. That is, second communication terminal 402 does not primarily receive the transmission signal whose reception strength is lower than the reception sensitivity as a signal. Here, the reception sensitivity is equal between second communication terminal 401 and second communication terminal 402. In other words, the value obtained by converting the radiated electromagnetic field strength near second communication terminal 402 of charging apparatus 202 into the reception strength of the transmission signal in second communication terminal 402 becomes lower than the reception intensity of second communication terminal 4. An antenna gain of electrode 42 may be reflected on the converted value.

In this case, since second communication terminal 4 does not receive the leakage signal as a signal, second communication terminal 4 can receive only the desired signal. That is, unlike Example 1, Example 2 allows second communication terminal 4 to extract only the desired signal without distinguishing the desired signal from the leakage signal by comparison of the reception strength of the transmission signal, thereby suppressing interference. Therefore, Example 2 simplifies processes after receipt of the transmission signal.

In the present exemplary embodiment, plural charging apparatuses 2, which are plural supply apparatuses, only need to be installed side by side, and the number of charging apparatuses 2 is not limited to two but may be three or more. For example, when six charging apparatuses 2 are installed side by side, one electric vehicle 1 is connected to one charging apparatus 2 out of these six charging apparatuses 2 via charging cable 5, and receives electric power supplied from one connected charging apparatus 2. Therefore, one charging apparatus 2 out of these six charging apparatuses 2 which is connected to electric vehicle 1 via charging cable 5 is a first supply apparatus. In this case, other supply apparatuses are other charging apparatuses 2 different from the first supply apparatus described above, and are not required to be adjacent to charging apparatus 2 as the one supply apparatus.

Other configurations and functions are similar to configurations and functions of Embodiment 1. The configuration of the present exemplary embodiment is applicable in combination with the configuration of each of Embodiments 2, 3, and 4, in addition to the configuration of Embodiment 1.

### Exemplary Embodiment 6

FIG. 14 is a block diagram of a communication system according to Exemplary Embodiment 6. In FIG. 14, components identical to those of the system according to Embodiment 1 illustrated in FIG. 1 are denoted by the same reference numerals. The communication system illustrated in FIG. 14 includes communication terminals 3b and 4b instead of communication terminals 3 and 4 of the communication system according to Embodiment 1 illustrated in FIG. 1.

Communication terminal 3b further includes grounding capacitor 35c connected in series between ground connection terminal 3116 of communication unit 31 and ground terminal 35 of communication terminal 3 illustrated in FIG. 1. In other words, ground terminal 35 connected to conductive part 131 allows communication unit 31 to be grounded to the body via grounding capacitor 35c in high-frequencies although communication unit 31 is not grounded to the body in a direct-current frequency. This configuration reduces impedance of a reference potential point of communication unit 31 compared with a case where ground terminal 35 of communication unit 31 is not electrically connected to conductive part 131 (electrically isolated), hence providing a stable potential of the reference potential point of communication unit 31.

Communication terminal 4b further includes grounding capacitor 45c connected in series between ground connection terminal 416 of communication unit 41 and ground terminal 45 of communication terminal 4 illustrated in FIG. 1. In other words, ground terminal 45 connected to housing 22 allows communication unit 41 to be grounded to the body via grounding capacitor 45c in high frequencies although communication unit 41 is not grounded to the body in a direct-current frequency. This configuration reduces impedance of the reference potential point of communication unit 41 compared with a case where ground terminal 45 of communication unit 41 is not electrically connected to housing 22 (electrically isolated), thus providing a stable potential of the reference potential point of communication unit 41.

In the communication system illustrated in FIG. 14, both communication terminals 3 and 4 of the communication system according to Embodiment 1 illustrated in FIG. 1 are replaced by communication terminals 3b and 4b. In the communication system according to Embodiment 6, communication terminal 3 out of communication terminals 3 and 4 of the communication system according to Embodiment 1 illustrated in FIG. 1 may be replaced by communication terminal 3b and may constitute the communication system together with communication terminal 4. Also, communication terminal 4 out of communication terminals 3 and 4 of the communication system according to Embodiment 1 illustrated in FIG. 1 may be replaced by communication terminal 4b and may constitute the communication system together with communication terminal 3.

Grounding capacitor 35c produces a similar effect by being connected in series between the reference potential point of communication unit 31 and ground terminal 35, instead of between ground connection terminal 316 of communication unit 31 and ground terminal 35. For example, grounding capacitor 35c may be connected in series between connection terminal 316 and each of reference potential point 311a of transmitting circuit 311, reference potential point 312a of receiving circuit 312, reference potential point 313a of controller 313, and reference potential point 314a of power supply circuit 314. Grounding capacitor 45c produces a similar effect by being connected in series between the reference potential point of communication unit 41 and ground terminal 45, instead of between ground connection terminal 416 of communication unit 41 and ground terminal 45. For example, grounding capacitor 45c may be connected in series between ground connection terminal 416 and each of reference potential point 411a of transmitting circuit 411, reference potential point 412a of receiving circuit 412, reference potential point 413a of controller 413, and reference potential point 414a of power supply circuit 414.

Other configurations and functions are similar to configurations and functions of Embodiment 1. The configuration of the present exemplary embodiment is applicable in combination with the configuration of each of Embodiments 2, 3, 4, and 5, in addition to the configuration of Embodiment 1.

1. A communication terminal comprising:
a communication unit provided in a supply apparatus that supplies electric power from a power source to an electric device through a feeding line, the communication unit being configured to communicate with a destination terminal provided in the electric device; and
a controller configured to control a switch to switch turning on and off of the switch electrically connected to the feeding line,
wherein the feeding line includes a first line that electrically connects between the power source and the switch, and a second line that electrically connects between the switch and the electric device,
wherein at least one of the communication unit and the destination terminal is located away via a space from a conductive member included in the feeding line as to be electrically connected to an electrode coupled via electric field to the conductive member,
wherein the communication unit is configured to communicate with the destination terminal by using a signal transmitted via a conductive member included in the second line of the conductive member as a medium, and
wherein the controller is configured to turn off the switch for a communication period for which the communication unit communicates with the destination terminal.

2. The communication terminal according to claim 1,
wherein the controller includes an input terminal configured to be electrically connected to a detector provided in the supply apparatus, the detector detecting a state of the supply apparatus, and
wherein the controller is configured to turn off the switch depending on a detection result of the detector which is input to the input terminal for a period different from the communication period.

3. The communication terminal according to claim 1, wherein a reference potential point of the communication unit is grounded.

4. The communication terminal according to claim 3, wherein the reference potential point of the communication unit is grounded via a frame ground of the supply apparatus.

5. An electrode-attached communication terminal comprising:
a communication unit provided in a supply apparatus that supplies electric power from a power source to an electric device through a feeding line, the communication unit being configured to communicate with a destination terminal provided in the electric device;
an electrode located away via a space from a conductive member included in the feeding line as to be coupled via electric field to the conductive member; and
a controller configured to control a switch to switch turning on and off of the switch electrically connected to the feeding line,
wherein the feeding line includes a first line that electrically connects between the power source and the switch, and a second line that electrically connects between the switch and the electric device,
wherein the communication unit is electrically connected to the electrode, and is configured to communicate with the destination terminal by using a signal transmitted via a conductive member included in the second line of the conductive member as a medium, and
wherein the controller is configured to turn off the switch for a communication period for which the communication unit communicates with the destination terminal.

6. A communication system comprising:
a first communication terminal provided in an electric device;
a second communication terminal provided in each of one or more supply apparatuses each supplying electric power from a power source to the electric device through a feeding line, the second communication terminal being configured to communicate with the first communication terminal,
wherein at least one of the first communication terminal and the second communication terminal includes an electrode, the electrode being located away via a space from a conductive member included in the feeding line as to be coupled via electric field to the conductive member,
wherein the feeding line includes a first line that electrically connects between the power source and a switch, and a second line that electrically connects between the switch and the electric device,
wherein the second communication terminal includes:
a communication unit configured to communicate with the first communication terminal by using a signal transmitted via a conductive member included in the second line of the conductive member as a medium, and
a controller configured to control the switch to switch turning on and off of the switch, and
wherein the controller is configured to turn off the switch for a communication period for which the communication unit communicates with the first communication terminal.

7. The communication system according to claim 6,
wherein the one or more supply apparatuses includes a plurality of supply apparatuses each supplying electric power to the electric device, and
wherein the plurality of supply apparatuses is electrically connected to each other via the first line.

8. The communication system according to claim 6,
wherein the electric device is an electric vehicle having a secondary battery installed thereto, and
wherein the one or more supply apparatuses are one or more charging apparatuses each supplying electric power to the electric device through the feeding line to charge the secondary battery.

9. The communication system according to claim 8, wherein the first communication terminal is configured to transmit, to the second communication terminal, identification information unique to the electric device by communication with the second communication terminal.

10. The communication system according to claim 9, wherein the second communication terminal is configured not to supply electric power from the one or more supply apparatuses to the electric device when verification of the identification information does not succeed.

11. An electric vehicle functioning as the electric device of the communication system according to claim 8.

12. A charging apparatus functioning as one of the one or more supply apparatuses of the communication system according to claim 8.
